(19) United States
(12) Patent Application Publication
(10) Pub. No.: US 2024/0027741 A1
(43) Pub. Date: Jan. 25, 2024

(54) LIGHT RECEIVING DEVICE, RECEPTION DEVICE, COMMUNICATION DEVICE, AND COMMUNICATION SYSTEM

(71) Applicant: NEC Corporation, Tokyo (JP)

(72) Inventors: Koya TAKATA, Tokyo (JP); Hisashi MIZUMOTO, Tokyo (JP); Fujio OKUMURA, Kanagawa (JP)

(73) Assignee: NEC Corporation, Tokyo (JP)

(21) Appl. No.: 18/220,637

(22) Filed: Jul. 11, 2023

(30) Foreign Application Priority Data
Jul. 19, 2022 (JP) 2022-114921

(51) Int. Cl. G02B 17/08; H04B 10/40

(52) U.S. Cl. CPC G02B 17/0884; H04B 10/40

(57) ABSTRACT

Provided is a light receiving device including a ball lens, a concave lens that is arranged in a light collecting region of the ball lens, a reflection element that is arranged in association with the concave lens and has a reflection surface that diffracts and reflects an optical signal collected by the concave lens, and a light receiving element that is arranged in association with the reflection element and receives the optical signal diffracted and reflected by the reflection surface of the reflection element.

This application is based upon and claims the benefit of priority from Japanese Patent Application No. 2022-114921, filed on Jul. 19, 2022, the disclosure of which is incorporated herein in its entirety by reference.

### TECHNICAL FIELD

The present disclosure relates to a light receiving device and the like used for receiving an optical signal propagating in a space.

### BACKGROUND ART

In optical space communication, an optical signal (hereinafter, also referred to as a spatial optical signal) propagating in a space is transmitted and received without using a medium such as an optical fiber. In order to receive a spatial optical signal propagating in a wide space, it is preferable to use a lens having as large a diameter as possible. Furthermore, for optical space communication, a light receiving element having a small capacitance is adopted in order to perform high-speed communication. Such a light receiving element has a small light receiving portion. Since a focal length of the lens is limited, it is difficult to guide spatial optical signals arriving from various directions to the small light receiving portion by using the large-diameter lens.

Patent literature 1 (JP 2004-138749 A) discloses a light receiving module. The module of Patent literature 1 includes a prism element, a first optical film, a second optical film, a heat dissipation substrate, a light emitting element, a light receiving element, and a condenser lens. The prism element is formed by stacking a plurality of light transmissive substrates and has a tip surface and an end surface parallel to each other, and side surfaces, and the end surface is fixed on a main substrate. The first optical film is arranged at a first interface of the plurality of substrates. The first optical film reflects transmission light incident from the side surface of the prism element toward the tip surface of the prism element, and transmits reception light incident from the tip surface of the prism element. The second optical film is arranged at a second interface of the plurality of substrates. The second optical film reflects reception light transmitted through the first optical film toward the side surface of the prism element. The heat dissipation substrate is fixed on the main substrate or formed integrally with the main substrate in such a way that a side surface thereof is parallel to the side surface of the prism element. The light emitting element is attached to the heat dissipation substrate in such a way that the transmission light is reflected by the first optical film. The light receiving element is attached to the heat dissipation substrate in such a way as to receive the reception light reflected by the second optical film. The condenser lens is provided between the tip surface of the prism element and an optical fiber. The module of Patent literature 1 is used to transmit and receive an optical signal via an optical fiber transmission line.

Patent literature 2 (JP 2017-123500 A) discloses an optical space communication device used for optical space communication. The device of Patent literature 2 includes a main mirror, a sub-mirror, a transmission lens, a reflection mirror, reception means, and angle deviation detection means. The main mirror has a through hole at the center. The sub-mirror has a through hole at the center, light reflected by the main mirror is incident on the sub-mirror, and the light is reflected toward the through hole of the main mirror as a first beam. The transmission lens is installed coaxially with the sub-mirror in an opening of the sub-mirror and refracts incident light in such a way as to pass through the through hole of the sub-mirror as a second beam. The reflection mirror has a through hole that reflects the first beam and allows the second beam to pass therethrough at the center. The reception means receives the first beam reflected by the reflection mirror. The angle deviation detection means receives the second beam that has passed through the through hole of the reflection mirror, and detects an angle deviation of the second beam.

In the module of Patent literature 1, optical coupling between the light emitting element and the light receiving element and the optical fiber is implemented by adjustment using one condenser lens. The module of Patent literature 1 is used for reception of the reception light transmitted through the optical fiber, and cannot be applied to reception of the spatial optical signal.

The device of Patent literature 2 is used for reception of the spatial optical signal arriving from one direction in a horizontal plane. The device of Patent literature 2 receives the spatial optical signal that has passed through the openings of the main mirror and the sub-mirror. Regarding to the spatial optical signal incident at an angle with respect to the horizontal plane, a ratio of signals passing through the openings of the main mirror and the sub-mirror decreases. Therefore, the device of Patent literature 2 cannot efficiently receive the spatial optical signal incident at an angle with respect to the horizontal plane.

An object of the present disclosure is to provide a light receiving device and the like capable of efficiently receiving a spatial optical signal.

### SUMMARY

A light receiving device according to one aspect of the present disclosure includes a ball lens, a concave lens that is arranged in a light collecting region of the ball lens, a reflection element that is arranged in association with the concave lens and has a reflection surface that diffracts and reflects an optical signal collected by the concave lens, and a light receiving element that is arranged in association with the reflection element and receives the optical signal diffracted and reflected by the reflection surface of the reflection element.

### BRIEF DESCRIPTION OF THE DRAWINGS

Exemplary features and advantages of the present invention will become apparent from the following detailed description when taken with the accompanying drawings in which:

FIG. 1 is a conceptual view illustrating an example of a configuration of a reception device according to a first example embodiment;

FIG. 2 is a conceptual view illustrating an example of collection of an optical signal by a concave lens included in the reception device according to the first example embodiment;

FIG. 3 is a conceptual view illustrating an example of collection of an optical signal by a ball lens in a case where the reception device according to the first example embodiment does not include the concave lens;

FIG. 4 is a conceptual view for explaining an example of reception of a spatial optical signal by the reception device according to the first example embodiment;

FIG. 5 is a conceptual view illustrating an example of a configuration of a reception device according to a second example embodiment;

FIG. 6 is a conceptual view illustrating the example of the configuration of the reception device according to the second example embodiment;

FIG. 7 is a conceptual view illustrating an example of a configuration of a concave lens array and a reflector included in the reception device according to the second example embodiment;

FIG. 8 is a conceptual view illustrating the example of the configuration of the concave lens array and the reflector included in the reception device according to the second example embodiment;

FIG. 9 is a conceptual view for explaining an example of reception of a spatial optical signal by the reception device according to the second example embodiment;

FIG. 10 is a conceptual view illustrating an example of a configuration of a reception device according to a modified example of the second example embodiment;

FIG. 11 is a conceptual view illustrating an example of a configuration of a reception device according to a third example embodiment;

FIG. 12 is a conceptual view illustrating the example of the configuration of the reception device according to the third example embodiment;

FIG. 13 is a conceptual view for explaining an example of reception of a spatial optical signal by the reception device according to the third example embodiment;

FIG. 14 is a conceptual view for explaining an example of reception of a spatial optical signal by the reception device according to the third example embodiment;

FIG. 15 is a conceptual view illustrating an example of a configuration of a reception device according to a fourth example embodiment;

FIG. 16 is a conceptual view illustrating the example of the configuration of the reception device according to the fourth example embodiment;

FIG. 17 is a conceptual view for explaining an example of reception of a spatial optical signal by the reception device according to the fourth example embodiment;

FIG. 18 is a conceptual view illustrating an example of a configuration of a reception device according to a first modified example of the fourth example embodiment;

FIG. 19 is a conceptual view illustrating an example of a configuration of a reception device according to a second modified example of the fourth example embodiment;

FIG. 20 is a block diagram illustrating an example of a configuration of a communication device according to a fifth example embodiment;

FIG. 21 is a conceptual view illustrating an example of a configuration of a transmission device included in the communication device according to the fifth example embodiment;

FIG. 22 is a conceptual view illustrating an example of a configuration of the communication system according to the fifth example embodiment;

FIG. 23 is a conceptual view for explaining an application example of the communication device according to the fifth example embodiment;

FIG. 24 is a conceptual view illustrating an example of a configuration of a light receiving device according to a sixth example embodiment; and

FIG. 25 is a block diagram illustrating an example of a hardware configuration that executes processing and control according to each example embodiment.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, directions of arrows in the drawings are merely examples and do not limit directions of light and signals. In addition, a line indicating a trajectory of light in the drawings is conceptual and does not accurately indicate an actual traveling direction or state of light. For example, in the drawings, a change in traveling direction or state of light due to refraction, reflection, diffusion, or the like at an interface between air and a substance may be omitted, or a light flux may be expressed by one line. In addition, hatching is not applied to cross sections in some cases when an example of a light path is illustrated or the configuration is complicated.

### First Example Embodiment

First, a reception device according to a first example embodiment will be described with reference to the drawings. The reception device of the present example embodiment is used for optical space communication in which an optical signal (hereinafter, also referred to as a spatial optical signal) propagating in a space is transmitted and received without using a medium such as an optical fiber. The reception device of the present example embodiment may be used for applications other than the optical space communication as long as the reception device receives light propagating in a space. In the present example embodiment, unless otherwise specified, the spatial optical signal is regarded as parallel light because the spatial optical signal arrives from a sufficiently distant position. The drawings used in the description of the present example embodiment are conceptual and do not accurately depict an actual structure.

(Configuration)

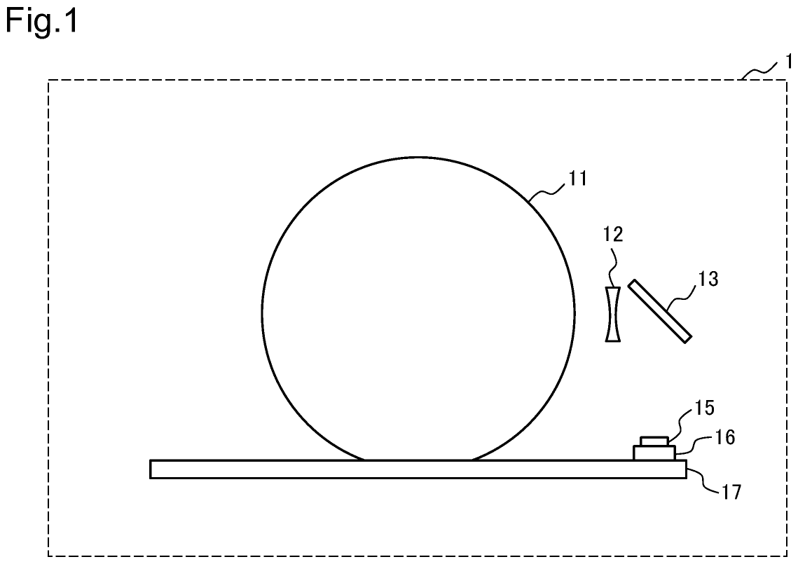

FIG. 1 is a conceptual view illustrating an example of a configuration of a reception device 1 according to the present example embodiment. The reception device 1 includes a ball lens 11, a concave lens 12, a reflection element 13, a light receiving element 15, a reception circuit 16, and a support substrate 17. The ball lens 11, the concave lens 12, the reflection element 13, and the light receiving element 15 are included in the light receiving device. FIG. 1 is a side view of the light receiving device as viewed from a lateral direction. A positional relationship among the ball lens 11, the concave lens 12, and the reflection element 13 is fixed by a support (not illustrated). In the present example embodiment, the support that fixes the positional relationship among the ball lens 11, the concave lens 12, and the reflection element 13 is omitted. The position of the reception circuit 16 is not particularly limited as long as reception of the spatial optical signal is not affected.

The ball lens 11 is a spherical lens. The ball lens 11 is an optical element that collects the spatial optical signal arriving from the outside. The ball lens 11 has a spherical shape when viewed from any angle. The ball lens 11 collects the incident spatial optical signal. Light (also referred to as an optical signal) derived from the spatial optical signal collected by the ball lens 11 is collected toward a light collecting region of the ball lens 11. The ball lens 11 has a spherical shape and thus collects the spatial optical signal arriving from any direction. That is, the ball lens 11 exhibits similar light collecting performance for the spatial optical signal arriving from any direction. The light incident on the ball lens 11 is refracted when entering the inside of the ball lens 11. The light traveling inside the ball lens 11 is refracted again when being emitted to the outside of the ball lens 11. Most of the light emitted from the ball lens 11 is collected in the light collecting region.

For example, the ball lens 11 can be formed of a material such as glass, crystal, or resin. In a case of receiving the spatial optical signal of a visible range, a material such as glass, crystal, or resin that transmits/refracts light of the visible range can be applied to the ball lens 11. For example, optical glass such as crown glass or flint glass can be applied to the ball lens 11. For example, crown glass such as boron kron (BK) can be applied to the ball lens 11. For example, flint glass such as lanthanum schwerflint (LaSF) can be applied to the ball lens 11. For example, quartz glass can be applied to the ball lens 11. For example, crystal such as sapphire can be applied to the ball lens 11. For example, a transparent resin such as acryl can be applied to the ball lens 11.

In a case where the spatial optical signal is light of a near-infrared range (hereinafter, also referred to as a near-infrared ray), a material that transmits a near-infrared ray is used for the ball lens 11. For example, in a case of receiving the spatial optical signal of the near-infrared range of about 1.5 micrometers (μm), a material such as silicon can be applied to the ball lens 11 in addition to glass, crystal, resin, and the like.

In a case where the spatial optical signal is light of an infrared range (hereinafter, also referred to as an infrared ray), a material that transmits an infrared ray is used for the ball lens 11. For example, in a case where the spatial optical signal is an infrared ray, a silicon-based material, a germanium-based material, or a chalcogenide-based material can be applied to the ball lens 11. The material of the ball lens 11 is not limited as long as light of a wavelength region of the spatial optical signal can be transmitted/refracted. The material of the ball lens 11 may be appropriately selected according to a required refractive index.

The concave lens 12 is arranged in the light collecting region including a light collecting point of the ball lens 11. The light collecting point of the ball lens 11 is not uniquely determined. Therefore, the concave lens 12 is arranged in the light collecting region including the light collecting point of the ball lens 11. In the example of FIG. 1, the concave lens 12 is arranged on a side (right side) of the ball lens 11. A principal surface of the concave lens 12 faces the ball lens 11. A plurality of concave lenses 12 may be arranged around the ball lens 11. For example, the plurality of concave lenses 12 are arranged in an annular form in such a way as to surround the ball lens 11.

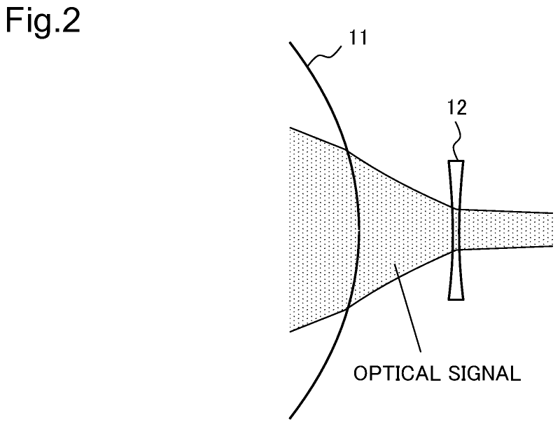

FIG. 2 is a conceptual view illustrating a state in which the optical signal collected by the ball lens 11 is collected by the concave lens 12. The optical signal collected by the ball lens 11 is incident on the concave lens 12. The concave lens 12 collects the incident optical signal in such a way as to be close to parallel light. The optical signal having passed through the concave lens 12 travels toward the reflection surface of the reflection element 13. The optical signal collected by the concave lens 12 enters the reflection surface of the reflection element 13 arranged downstream in a certain direction. The reflection element 13 functions for parallel light arriving from a certain direction. Therefore, in the present example embodiment, the optical signal collected by the ball lens 11 is converted into a light flux close to parallel light by the concave lens 12.

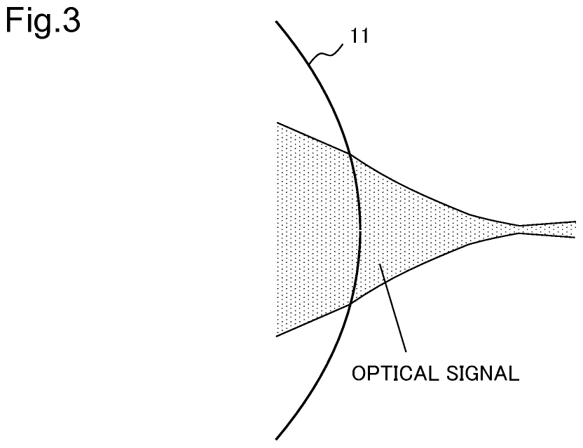

FIG. 3 is a conceptual view illustrating a state of collection of the optical signal by the ball lens 11 in a case where the concave lens 12 is not provided (comparative example). In a case where the concave lens 12 is not provided, the optical signal collected by the ball lens 11 does not enter the reflection surface of the reflection element 13 in a certain direction. Therefore, in the example of FIG. 3, since the direction in which the optical signal enters the reflection surface of the reflection element 13 cannot be limited, the reflection element 13 arranged downstream does not sufficiently function.

In a case where the spatial optical signal is a near-infrared ray, a material that transmits near-infrared rays is used for the concave lens 12. For example, in a case of receiving the spatial optical signal of the near-infrared range of about 1.5 micrometers (μm), a material such as silicon can be applied to the concave lens 12 in addition to glass, crystal, resin, and the like. In a case where the spatial optical signal is an infrared ray, a material that transmits infrared rays is used for the concave lens 12. For example, in a case where the spatial optical signal is an infrared ray, a silicon-based material, a germanium-based material, or a chalcogenide-based material can be applied to the concave lens 12. The material of the concave lens 12 is not limited as long as light of a wavelength region of the spatial optical signal can be transmitted/refracted. The material of the concave lens 12 may be appropriately selected according to a required refractive index.

The reflection element 13 has the reflection surface that diffracts and reflects the incident light. For example, the reflection element 13 is implemented by a reflection type diffractive optical element (DOE). For example, the reflection element 13 is a reflection type diffractive optical element having a curved reflection surface. Sub-micron-scale irregularities are formed on the reflection surface of the reflection element 13. The irregularities of the reflection surface can be formed by three-dimensional nanoimprinting using a dedicated mold. The reflection surface of the reflection element 13 are oriented obliquely with respect to the principal surface of the concave lens 12 and a light receiving surface of the light receiving element 15 positioned downstream. For example, the angle of the reflection surface of the reflection element 13 is adjusted to 45 degrees with respect to the principal surface of the concave lens 12 and the light receiving surface of the light receiving element 15 positioned downstream. The optical signal collected by the concave lens 12 is incident on the reflection surface of the reflection element 13. The optical signal incident on the reflection surface of the reflection element 13 is collected toward a light receiving portion of the light receiving element 15.

The light receiving element 15 is arranged over an upper surface of the support substrate 17. In the example of FIG. 1, the light receiving element 15 is arranged on the reception circuit 16. The light receiving element 15 includes the light receiving portion that receives an optical signal. The light receiving surface of the light receiving element 15 is oriented toward the reflection surface of the reflection element 13 arranged above the light receiving element 15. The optical signal collected by the reflection element 13 is incident on the light receiving portion of the light receiving element 15. The light receiving element 15 receives the optical signal incident on the light receiving portion. The light receiving element 15 converts the received optical signal into an electric signal. The converted electric signal is output to the reception circuit 16.

The light receiving element 15 receives light of a wavelength region of the spatial optical signal to be received. For example, the light receiving element 15 has sensitivity to light of the visible range. For example, the light receiving element 15 has sensitivity to light of the infrared range. The light receiving element 15 is sensitive to light having a wavelength in a band of 1.5 μm (micrometer), for example. The wavelength band of light to which the light receiving element 15 has sensitivity is not limited to the band of 1.5 μm. Any wavelength band of the light received by the light receiving element 15 can be set in accordance with a wavelength of the spatial optical signal transmitted from a transmission device (not illustrated). The wavelength band of the light received by the light receiving element 15 may be set to, for example, a band of 0.8 μm, a band of 1.55 μm, or a band of 2.2 μm. Further, the wavelength band of the light received by the light receiving element 15 may be, for example, a band of 0.8 to 1 μm. A shorter wavelength band is advantageous for optical space communication during rainfall because absorption by moisture in the atmosphere is small. In a case where the light receiving element 15 is saturated with intense sunlight, the light receiving element cannot read the optical signal derived from the spatial optical signal. Therefore, a color filter that selectively passes light of the wavelength band of the spatial optical signal may be installed upstream of the light receiving element 15.

For example, the light receiving element 15 can be implemented by an element such as a photodiode or a phototransistor. For example, the light receiving element 15 is implemented by an avalanche photodiode. The light receiving element 15 implemented by the avalanche photodiode can support high-speed communication. The light receiving element 15 may be implemented by an element other than a photodiode, a phototransistor, or an avalanche photodiode as long as an optical signal can be converted into an electric signal. In order to increase the communication speed, the light receiving portion of the light receiving element 15 is preferably as small as possible. For example, the light receiving portion of the light receiving element 15 has a square light receiving surface of which a side has a size of about 5 mm (mm). For example, the light receiving portion of the light receiving element 15 has a circular light receiving surface having a diameter of about 0.1 to 0.3 mm. It is sufficient if the size and shape of the light receiving portion of the light receiving element 15 are selected according to the wavelength band of the spatial optical signal, the communication speed, and the like.

The reception circuit 16 receives the electric signal output from the light receiving element 15. The reception circuit 16 decodes the received electric signal. The reception circuit 16 outputs the decoded signal. The signal decoded by the reception circuit 16 is used for any purpose. The use of the signal decoded by the reception circuit 16 is not particularly limited. In the example of FIG. 1, the reception circuit 16 is arranged on the upper surface of the support substrate 17. The light receiving element 15 is arranged on the reception circuit 16. The reception circuit 16 may be arranged not on the upper surface of the support substrate 17 but inside the support substrate 17. The reception circuit 16 may be arranged at a position different from the support substrate 17. The position where the reception circuit 16 is arranged is not limited.

The support substrate 17 is a substrate that supports the ball lens 11, the concave lens 12, the reflection element 13, the light receiving element 15, and the reception circuit 16. The support that fixes the ball lens 11, the concave lens 12, the reflection element 13, the light receiving element 15, and the reception circuit 16 to the support substrate 17 is omitted. The material and shape of the support substrate 17 are not particularly limited.

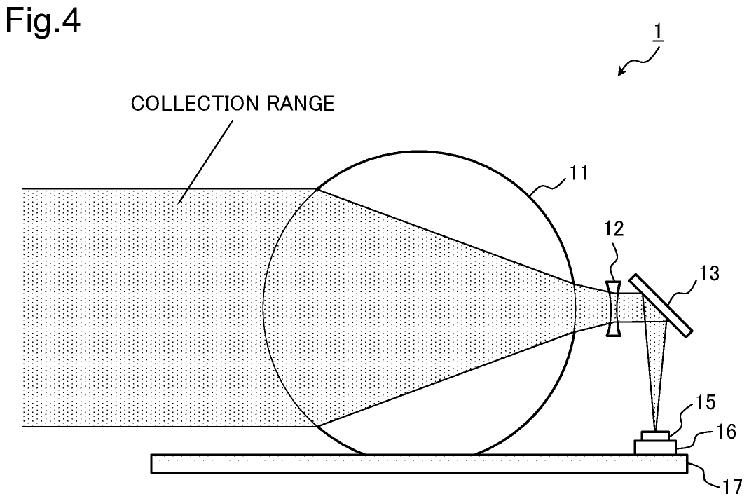

FIG. 4 is a conceptual view illustrating a state in which the spatial optical signal is collected toward the light receiving element 15. In FIG. 4, an example of a collection range of the spatial optical signal and a traveling range of the optical signal is indicated by hatching. The spatial optical signal arriving at the ball lens 11 is collected by the ball lens 11. The optical signal collected by the ball lens 11 is collected toward the concave lens 12. The optical signal having passed through the concave lens 12 is converted into a light flux close to parallel light. The optical signal having passed through the concave lens 12 is reflected by the reflection surface of the reflection element 13 and collected toward the light receiving portion of the light receiving element 15. The optical signal collected on the light receiving portion is received by the light receiving element 15. The optical signal received by the light receiving element 15 is decoded by the reception circuit 16.

As described above, the reception device of the present example embodiment includes the ball lens, the concave lens, the reflection element, the light receiving element, and the reception circuit. The ball lens, the concave lens, the reflection element, and the light receiving element are included in the light receiving device. The ball lens is a spherical lens. The concave lens is arranged in the light collecting region of the ball lens. The reflection element is arranged in association with the concave lens. The reflection element has the reflection surface that diffracts and reflects the optical signal collected by the concave lens. For example, the reflection element is a reflection type diffractive optical element. The light receiving element is arranged in association with the reflection element. The light receiving element receives the optical signal diffracted and reflected by the reflection surface of the reflection element. The reception circuit acquires a signal received by the light receiving device. The reception circuit decodes the acquired signal.

The reception device of the present example embodiment collects, by the ball lens, the spatial optical signal transmitted from a communication target. The optical signal collected by the ball lens is converted into a light flux close to parallel light by the concave lens. The optical signal having passed through the concave lens is collected on the reflection surface of the reflection element. The optical signal collected on the reflection surface of the reflection element is diffracted and reflected by the reflection surface and collected on the light receiving portion of the light receiving element. The light receiving element receives the collected optical signal. The light receiving element converts the received optical signal into an electric signal. In the reception device of the present example embodiment, a direction in which the optical signal is received by the light receiving element can be greatly changed with respect to the arrival direction of the spatial optical signal by the reflection element. In the reception device of the present example embodiment, since there are few limitations on the position of the light receiving element with respect to the ball lens, the light receiving element can be arranged at a position where the optical signal can be efficiently received. Therefore, with the reception device of the present example embodiment, the spatial optical signal can be efficiently received.

### Second Example Embodiment

Next, a reception device according to a second example embodiment will be described with reference to the drawings. The reception device of the present example embodiment has a configuration for receiving spatial optical signals arriving from various directions. In the present example embodiment, unless otherwise specified, the spatial optical signal is regarded as parallel light because the spatial optical signal arrives from a sufficiently distant position. The drawings used in the description of the present example embodiment are conceptual and do not accurately depict an actual structure.

(Configuration)

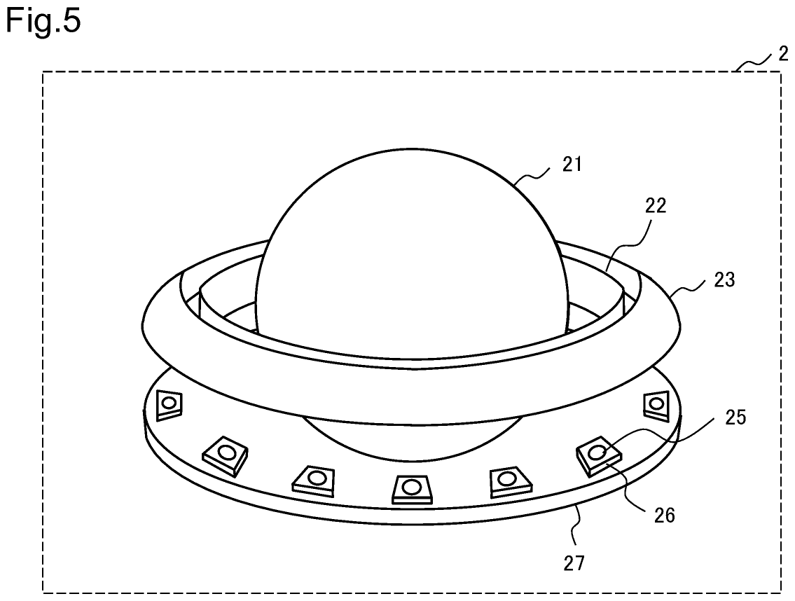

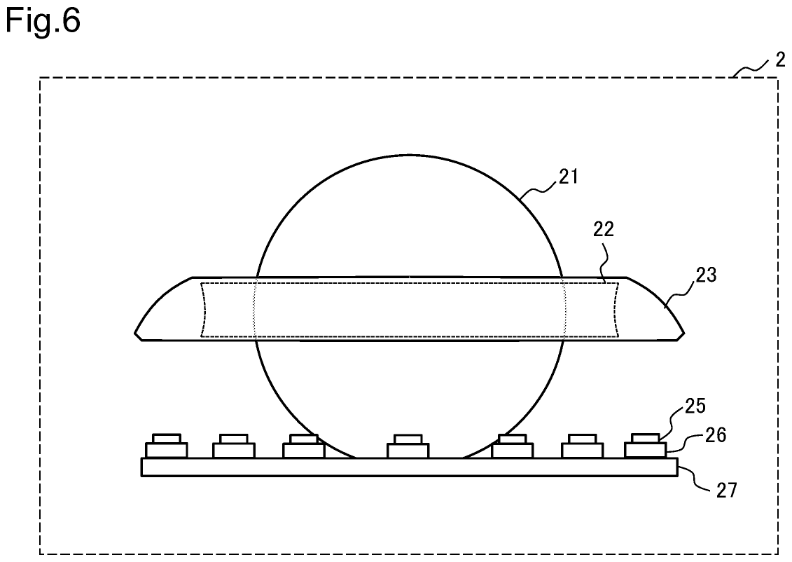

FIGS. 5 and 6 are conceptual views illustrating an example of a configuration of a reception device 2 according to the present example embodiment. The reception device 2 includes a ball lens 21, a concave lens array 22, a reflector 23, a plurality of light receiving elements 25, a plurality of reception circuits 26, and a support substrate 27. The ball lens 21, the concave lens array 22, the reflector 23, and the plurality of light receiving elements 25 are included in a light receiving device. FIG. 5 is an oblique view of the light receiving device as viewed obliquely from above. FIG. 6 is a side view of the light receiving device as viewed from the lateral direction. A positional relationship among the ball lens 21, the concave lens array 22, and the reflector 23 is fixed by a support (not illustrated). In the present example embodiment, a support that fixes the positional relationship among the ball lens 21, the concave lens array 22, and the reflector 23 is omitted. The position of the reception circuit 26 is not particularly limited as long as reception of the spatial optical signal is not affected. The reception circuit 26 may be implemented by a single common circuit for each of the plurality of light receiving elements 25.

The ball lens 21 has the same configuration as the ball lens 11 of the first example embodiment. The ball lens 21 collects the spatial optical signal arriving from the outside. The ball lens 21 collects the incident spatial optical signal. Light (also referred to as an optical signal) derived from the spatial optical signal collected by the ball lens 21 is collected toward a light collecting region of the ball lens 21.

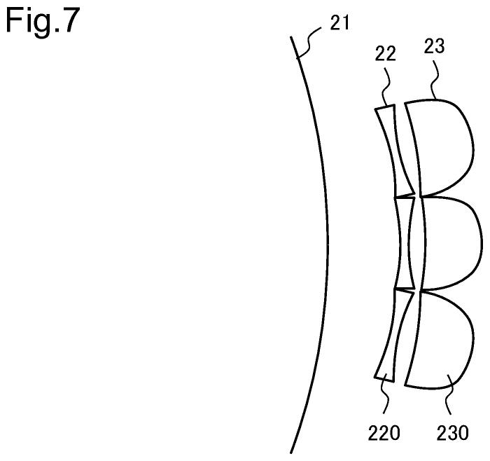

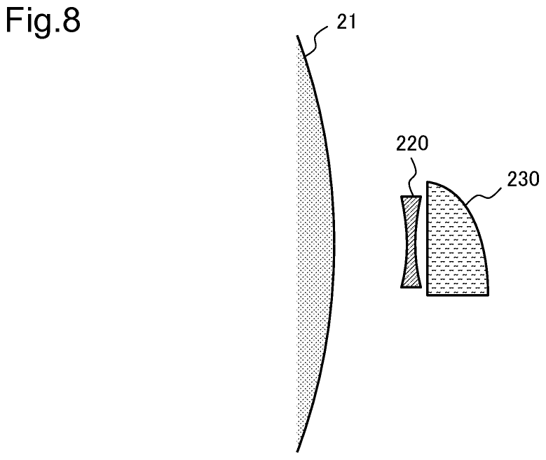

The concave lens array 22 has a configuration in which a plurality of concave lenses are arranged in an annular form. The concave lens array 22 is arranged in a light collecting region including a light collecting point of the ball lens 21. FIGS. 7 and 8 are enlarged conceptual views of a portion of the concave lens array 22. FIG. 7 is a conceptual view of the portion of the concave lens array 22 and a portion of the reflector 23 included in the light receiving device as viewed from above. FIG. 8 is a cross-sectional view of the portion of the concave lens array 22 and the portion of the reflector 23 included in the light receiving device. The concave lens array 22 includes a plurality of concave lenses 220. The plurality of concave lenses 220 included in the concave lens array 22 have a function similar to that of the concave lens 12 of the first example embodiment. The plurality of concave lenses 220 included in the concave lens array 22 are arranged in an annular form around the ball lens 21. The plurality of concave lenses 220 included in the concave lens array 22 may be integrated.

Each of the plurality of concave lenses 220 is associated with one of a plurality of reflection elements 230 included in the reflector 23. The optical signal collected by the ball lens 21 is incident on the concave lens 220. The concave lens 220 converts the incident optical signal into a light flux close to parallel light. The optical signal having passed through the concave lens 220 travels toward a reflection surface of the reflection element 230 associated with the concave lens 220.

The reflector 23 has a configuration in which the plurality of reflection elements 230 are arranged in an annular form. The reflector 23 includes the plurality of reflection elements 230. The plurality of reflection elements 230 included in the reflector 23 has a function similar to that of the reflection element 13 of the first example embodiment. The plurality of reflection elements 230 included in the reflector 23 are arranged in an annular form around the ball lens 21. Each of the plurality of reflection elements 230 is associated with any one of the plurality of concave lenses 220 included in the concave lens array 22. Each of the plurality of reflection elements 230 is associated with any one of a plurality of optical elements. The reflection element 230 is arranged downstream of the associated concave lens 220. The plurality of reflection elements 230 included in the reflector 23 may be integrated.

The reflection element 230 has the reflection surface that diffracts and reflects the incident light. For example, the reflection element 230 is implemented by a reflection type diffractive optical element (DOE). The reflection surface of the reflection element 230 is oriented obliquely with respect to a principal surface of the associated concave lens 220 and a light receiving portion of the light receiving element 25 positioned downstream. For example, the angle of the reflection surface of the reflection element 230 is adjusted to 45 degrees with respect to the principal surface of the associated concave lens 220 and a light receiving surface of the light receiving element 25 positioned downstream. The optical signal collected by the concave lens 220 is incident on the reflection surface of the reflection element 230. The optical signal incident on the reflection surface of the reflection element 230 is collected toward the light receiving portion of the associated light receiving element 25.

The light receiving element 25 has the same configuration as the light receiving element 15 of the first example embodiment. The plurality of light receiving elements 25 are arranged over an upper surface of the support substrate 27. The plurality of light receiving elements 25 are included in a light receiving element array. In the example of FIGS. 5 and 6, the plurality of light receiving elements 25 are arranged on the reception circuits 26. The light receiving element 25 includes the light receiving portion that receives an optical signal. The light receiving portion of the light receiving element 25 is oriented toward the reflection surface of the associated reflection element 230. The optical signal collected by the associated reflection element 230 is incident on the light receiving portion of the light receiving element 25. The light receiving element 25 receives the optical signal incident on the light receiving portion. The light receiving element 25 converts the received optical signal into an electric signal. The converted electric signal is output to the reception circuit 26.

The reception circuit 26 has the same configuration as the reception circuit 16 of the first example embodiment. The reception circuit 26 is associated with any one of the plurality of light receiving elements 25. The reception circuit 26 may be implemented by a single common circuit for each of the plurality of light receiving elements 25. The reception circuit 26 receives the electric signal output from the associated light receiving element 25. The reception circuit 26 decodes the received electric signal. The reception circuit 26 outputs the decoded signal. The signal decoded by the reception circuit 26 is used for any purpose. The use of the signal decoded by the reception circuit 26 is not particularly limited. In the example of FIGS. 5 and 6, the reception circuit 26 is arranged on the upper surface of the support substrate 27. The light receiving element 25 associated with the reception circuit 26 is arranged on the reception circuit 26. The reception circuit 26 may be arranged not on the upper surface of the support substrate 27 but inside the support substrate 27. The reception circuit 26 may be arranged at a position different from the support substrate 27. The position where the reception circuit 26 is arranged is not limited.

The support substrate 27 is a substrate that supports the ball lens 21, the concave lens array 22, the reflector 23, the light receiving element 25, and the reception circuit 26. The support that fixes the ball lens 21, the concave lens array 22, the reflector 23, the light receiving element 25, and the reception circuit 26 to the support substrate 27 is omitted. The material and shape of the support substrate 27 are not particularly limited.

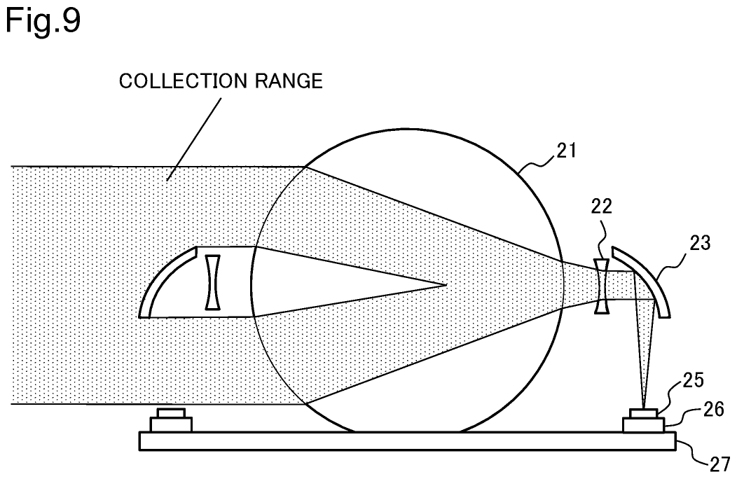

FIG. 9 is a conceptual view illustrating a state in which the spatial optical signal is collected toward the light receiving element 25. In FIG. 9, an example of a collection range of the spatial optical signal and a traveling range of the optical signal is indicated by hatching. The spatial optical signal arriving at the ball lens 21 is collected by the ball lens 21. The optical signal collected by the ball lens 21 is collected toward any one of the concave lenses 220 included in the concave lens array 22. The optical signal that has reached the concave lens 220 is converted into a light flux close to parallel light. The optical signal collected by the concave lens 220 is reflected by the reflection surface of the reflection element 230 associated with the concave lens 220 and is collected toward the light receiving portion of the light receiving element 25. The optical signal collected on the light receiving portion is received by the light receiving element 25. The optical signal received by the light receiving element 25 is decoded by the reception circuit 26.

### Modified Example

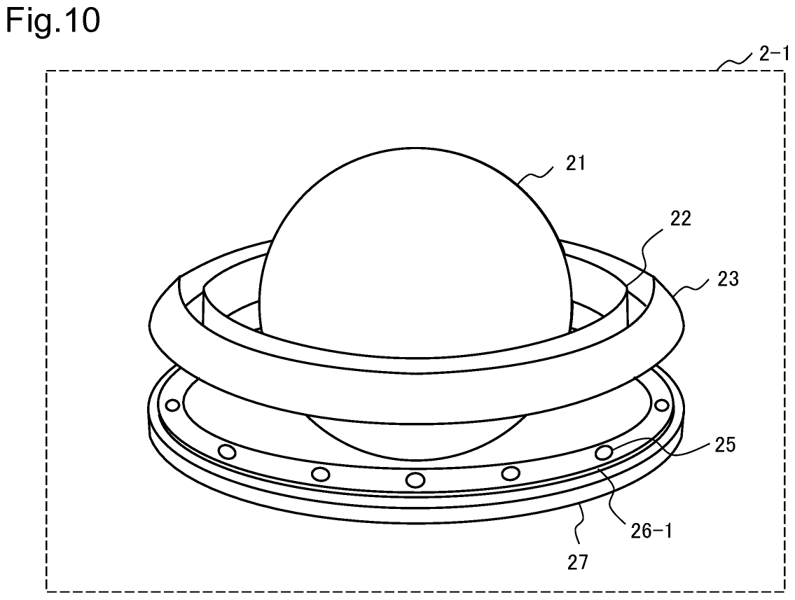

Next, a modified example of the reception device 2 of the present example embodiment will be described. FIG. 10 is a conceptual view illustrating an example of a configuration of a reception device 2-1 according to the modified example. FIG. 10 is a plan view of the reception device 2-1 as viewed from obliquely above. The reception device 2-1 of the present modified example includes a reception circuit 26-1 different from the configuration in FIGS. 5 and 6. A configuration other than the reception circuit 26-1 included in the reception device 2-1 is similar to the configuration in FIGS. 5 and 6.

The reception circuit 26-1 is formed on an annular substrate. A plurality of light receiving elements 25 are arranged on the reception circuit 26-1. The reception circuit 26-1 is implemented by a single common circuit for the plurality of light receiving elements 25. The reception circuit 26-1 receives electric signals output from the plurality of light receiving elements 25. The reception circuit 26-1 decodes the received electric signal. The reception circuit 26-1 outputs the decoded signal. The signal decoded by the reception circuit 26-1 is used for any purpose. The use of the signal decoded by the reception circuit 26-1 is not particularly limited. In the example of FIG. 10, the reception circuit 26-1 is arranged on the upper surface of the support substrate 27. The reception circuit 26-1 may be arranged not on the upper surface of the support substrate 27 but inside the support substrate 27. The reception circuit 26-1 may be arranged at a position different from the support substrate 27. The position where the reception circuit 26-1 is arranged is not limited.

The reception device 2-1 of the present modified example can collectively receive the electric signals output from the plurality of light receiving elements 25. A reception strength of the optical signal is maximized in the light receiving element 25 arranged at a position opposite to an arrival direction of the spatial optical signal. Therefore, according to the present modified example, the arrival direction of the spatial optical signal can be estimated by comparing reception strengths of the optical signals received by the plurality of light receiving elements 25. In the reception device 2-1 of the present modified example, the plurality of light receiving elements 25 are arranged on the single reception circuit 26-1. Therefore, according to the present modified example, a positional relationship among the plurality of light receiving elements 25 is fixed, and thus, device structure simplification is achieved.

As described above, the reception device of the present example embodiment includes the ball lens, the concave lens array, the reflector, the light receiving element array, and the reception circuit. The ball lens, the concave lens array, the reflector, and the light receiving element array are included in the light receiving device. The ball lens is a spherical lens. The concave lens array has a structure in which the plurality of concave lenses are arranged in an annular form. The plurality of concave lenses included in the concave lens array are arranged in the light collecting region of the ball lens. The plurality of reflection elements are arranged in an annular form around the concave lens array. The reflector includes the plurality of reflection elements. The reflection element is arranged in association with any one of the plurality of concave lenses included in the concave lens array. The reflection element has the reflection surface that diffracts and reflects the optical signal collected by the concave lens. The light receiving element array includes the plurality of light receiving elements. The light receiving element is arranged in association with any one of the plurality of reflection elements included in the reflector. The light receiving element receives the optical signal diffracted and reflected by the reflection surface of the reflection element. The reception circuit acquires a signal received by the light receiving device. The reception circuit decodes the acquired signal.

The reception device of the present example embodiment collects, by the ball lens, the spatial optical signal transmitted from a communication target. The optical signal collected by the ball lens is converted into a light flux close to parallel light by any one of the concave lenses included in the concave lens array. The optical signal having passed through the concave lens is collected on the reflection surface of the reflection element associated with the concave lens. The optical signal collected on the reflection surface of the reflection element is diffracted and reflected by the reflection surface and collected on the light receiving portion of the light receiving element. For example, the reflection element is a reflection type diffractive optical element. The light receiving element receives the collected optical signal. The light receiving element converts the received optical signal into an electric signal. With the reception device of the present example embodiment, the spatial optical signals arriving from various directions can be efficiently received by using the concave lens array and the reflector arranged in an annular form around the ball lens.

### Third Example Embodiment

Next, a reception device according to a third example embodiment will be described with reference to the drawings. The reception device of the present example embodiment is different from those of the first to second example embodiments in including a liquid crystal lens. In the present example embodiment, unless otherwise specified, the spatial optical signal is regarded as parallel light because the spatial optical signal arrives from a sufficiently distant position. The drawings used in the description of the present example embodiment are conceptual and do not accurately depict an actual structure.

(Configuration)

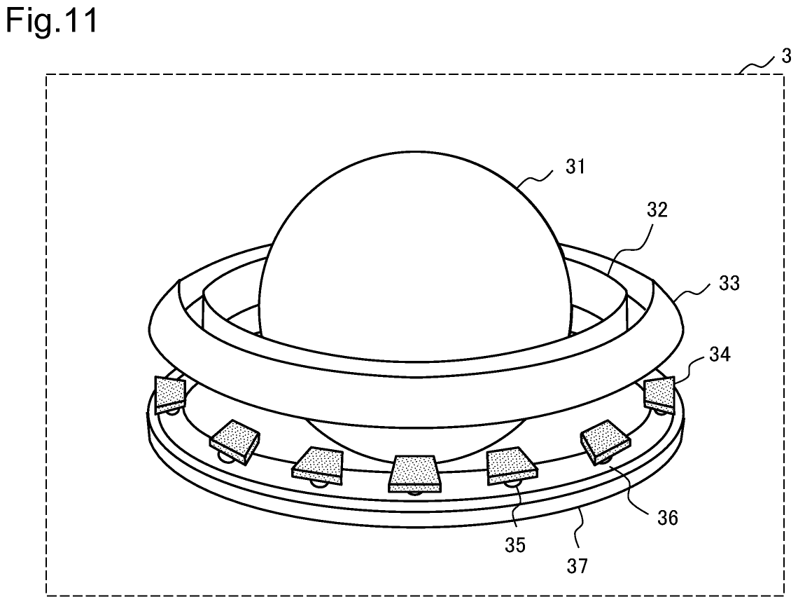

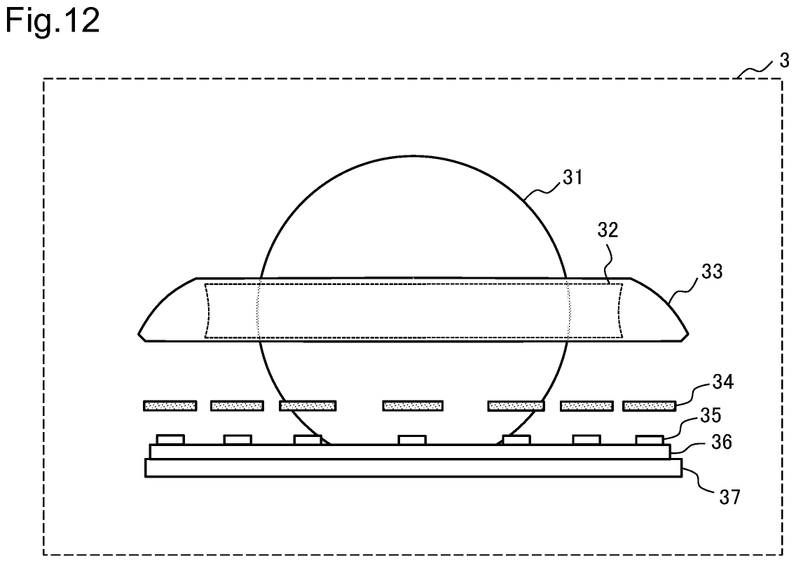

FIGS. 11 and 12 are conceptual views illustrating an example of a configuration of a reception device 3 according to the present example embodiment. The reception device 3 includes a ball lens 31, a concave lens array 32, a reflector 33, a plurality of liquid crystal lenses 34, a plurality of light receiving elements 35, a reception circuit 36, and a support substrate 37. The ball lens 31, the concave lens array 32, the reflector 33, the liquid crystal lenses 34, and the light receiving elements 35 are included in a light receiving device. FIG. 11 is an oblique view of the light receiving device as viewed obliquely from above. FIG. 12 is a side view of the light receiving device as viewed from the lateral direction. A positional relationship among the ball lens 31, the concave lens array 32, the reflector 33, and the liquid crystal lenses 34 is fixed by a support (not illustrated). In the present example embodiment, a support that fixes the positional relationship among the ball lens 31, the concave lens array 32, the reflector 33, and the liquid crystal lenses 34 is omitted. The position of the reception circuit 36 is not particularly limited as long as reception of the spatial optical signal is not affected. In the present example embodiment, the reception circuit 36 is implemented by a single common circuit for the plurality of light receiving elements 35.

The ball lens 31 has the same configuration as the ball lens 11 of the first example embodiment. The ball lens 31 collects the spatial optical signal arriving from the outside. The ball lens 31 collects the incident spatial optical signal. Light (also referred to as an optical signal) derived from the spatial optical signal collected by the ball lens 31 is collected toward a light collecting region of the ball lens 31.

The concave lens array 32 has the same configuration as the concave lens array 22 of the second example embodiment. The concave lens array 32 has a configuration in which a plurality of concave lenses are arranged in an annular form. The concave lens array 32 is arranged in a light collecting region including a light collecting point of the ball lens 31. The plurality of concave lenses included in the concave lens array 32 have a function similar to that of the concave lens 12 of the first example embodiment. The plurality of concave lenses included in the concave lens array 32 are arranged in an annular form around the ball lens 31. The plurality of concave lenses included in the concave lens array 32 may be integrated.

Each of the plurality of concave lenses is associated with one of a plurality of reflection elements included in the reflector 33. The optical signal collected by the ball lens 31 is incident on the concave lens included in the concave lens array 32. The concave lens converts the incident optical signal into a light flux close to parallel light. The optical signal having passed through the concave lens travels toward a reflection surface of the reflection element associated with the concave lens.

The reflector 33 has a configuration in which the plurality of reflection elements are arranged in an annular form. The reflector 33 includes the plurality of reflection elements. The plurality of reflection elements included in the reflector 33 has a function similar to that of the reflection element 13 of the first example embodiment. The plurality of reflection elements included in the reflector 33 are arranged in an annular form around the ball lens 31. Each of the plurality of reflection elements is associated with any one of the plurality of concave lenses included in the concave lens array 32. Each of the plurality of reflection elements is associated with any one of the plurality of optical elements. The reflection element is arranged downstream of the associated concave lens. The plurality of reflection elements included in the reflector 33 may be integrated.

The reflection element has the reflection surface that diffracts and reflects the incident light. For example, the reflection element is implemented by a reflection type diffractive optical element (DOE). The reflection element of the present example embodiment may be a plane mirror. The reflection surface of the reflection element is oriented obliquely with respect to a principal surface of the associated concave lens and a light receiving surface of the light receiving element 35 positioned downstream. For example, the angle of the reflection surface of the reflection element is adjusted to 45 degrees with respect to the principal surface of the associated concave lens and the light receiving surface of the light receiving element 35 positioned downstream. The optical signal collected by the concave lens is incident on the reflection surface of the reflection element. The optical signal incident on the reflection surface of the reflection element is collected toward a light receiving portion of the associated light receiving element 35.

The liquid crystal lens 34 is arranged between the associated reflector 33 and light receiving element 35. The liquid crystal lens 34 is a lens using liquid crystal. The liquid crystal lens 34 of the present example embodiment is a transmission type. For example, the liquid crystal lens 34 has a structure in which a liquid crystal lens body in which liquid crystal is sealed between two layers of alignment films is sandwiched between two layers of transparent conductive films. In the liquid crystal lens 34, a refractive index changes according to a voltage applied between the two layers of transparent conductive films. A focal length range of the liquid crystal lens 34 is set according to a refractive index of a material of the liquid crystal lens 34. A lens region is formed at any position in the liquid crystal lens 34 under the control of the reception circuit 36. For example, the lens region can be formed at any position in the liquid crystal lens 34 by adjusting a portion to which the voltage is applied. A focal length of the lens region formed in the liquid crystal lens 34 can be changed according to the applied voltage. A plurality of lens regions can be formed the in liquid crystal lens 34. A focusing direction and the focal length of the lens region formed in the liquid crystal lens 34 can be individually set by adjusting the applied voltage. The liquid crystal lens 34 corrects guidance of the optical signal by the reflection type diffractive optical element (DOE). If the liquid crystal lens 34 is used, the optical signal can be guided toward the light receiving portion of the light receiving element 35 with high accuracy, and the degree of light collection can be improved. For example, a transmission type diffractive optical element (DOE) may be arranged instead of the liquid crystal lens 34.

The liquid crystal lens 34 diffracts the optical signal incident on the lens region from an incident surface under the control of the reception circuit 36. The optical signal diffracted by the liquid crystal lens 34 is emitted from an emission surface of the liquid crystal lens 34 toward a region where the light receiving element 35 is arranged. That is, an emission direction of the optical signal incident on the liquid crystal lens 34 is controlled by the reception circuit 36, and the optical signal is focused toward the light receiving portion of the light receiving element 35.

The light receiving element 35 has the same configuration as the light receiving element 15 of the first example embodiment. The plurality of light receiving elements 35 are arranged over an upper surface of the support substrate 37. The plurality of light receiving elements 35 are included in a light receiving element array. In the example of FIGS. 11 and 12, the plurality of light receiving elements 35 are arranged on the reception circuit 36. The light receiving element 35 includes the light receiving portion that receives an optical signal. The light receiving portion of the light receiving element 35 is oriented toward the emission surface of the associated liquid crystal lens 34. The optical signal collected by the associated liquid crystal lens 34 is incident on the light receiving portion of the light receiving element 35. The light receiving element 35 receives the optical signal incident on the light receiving portion. The light receiving element 35 converts the received optical signal into an electric signal. The converted electric signal is output to the reception circuit 36.

The reception circuit 36 is implemented by a single common circuit for the plurality of light receiving elements 35. The reception circuit 36 receives the electric signal output from the light receiving element 35. The reception circuit 36 decodes the received electric signal. The reception circuit 36 outputs the decoded signal. The signal decoded by the reception circuit 36 is used for any purpose. The use of the signal decoded by the reception circuit 36 is not particularly limited. In the example of FIGS. 11 and 12, the reception circuit 36 is arranged on the upper surface of the support substrate 37. The light receiving element 35 is arranged on the reception circuit 36. The reception circuit 36 may be arranged not on the upper surface of the support substrate 37 but inside the support substrate 37. The reception circuit 36 may be arranged at a position different from the support substrate 37. The position where the reception circuit 36 is arranged is not limited.

Further, the reception circuit 36 controls the liquid crystal lens 34. The reception circuit 36 controls the liquid crystal lens 34 in such a way that the optical signal incident on the incident surface of the liquid crystal lens 34 is emitted toward the position (a predetermined region) of the light receiving portion of the light receiving element 35. For example, the reception circuit 36 includes a control circuit (not illustrated) implemented by a microcomputer including a processor and a memory. For example, the reception circuit 36 forms the lens region at a desired position in the liquid crystal lens 34 by controlling a voltage applied to the liquid crystal lens 34. The reception circuit 36 changes a refractive index of the lens region by adjusting the voltage applied to the liquid crystal lens 34. When the refractive index of the lens region is changed, the spatial optical signal incident on the liquid crystal lens 34 is appropriately diffracted according to the refractive index of the lens region. That is, the spatial optical signal incident on the liquid crystal lens 34 is diffracted according to an optical characteristic of the lens region. A method for driving the liquid crystal lens 34 by the reception circuit 36 is not limited to the method described above. Further, a control circuit that controls the liquid crystal lens 34 may be provided separately from the reception circuit 36.

The support substrate 37 is a substrate that supports the ball lens 31, the concave lens array 32, the reflector 33, the liquid crystal lenses 34, the light receiving elements 35, and the reception circuit 36. The support that fixes the ball lens 31, the concave lens array 32, the reflector 33, the liquid crystal lenses 34, the light receiving elements 35, and the reception circuit 36 to the support substrate 37 is omitted. The material and shape of the support substrate 37 are not particularly limited.

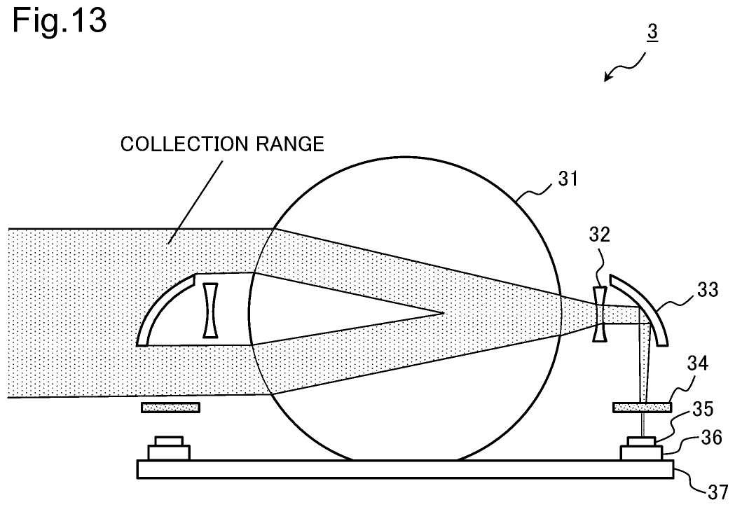

FIG. 13 is a conceptual view illustrating a state in which the spatial optical signal is collected toward the light receiving element 35. In FIG. 13, an example of a collection range of the spatial optical signal and a traveling range of the optical signal is indicated by hatching. The spatial optical signal arriving at the ball lens 31 is collected by the ball lens 31. The optical signal collected by the ball lens 31 is collected toward any one of the concave lenses included in the concave lens array 32. The optical signal that has reached the concave lens is converted into a light flux close to parallel light. The optical signal collected by the concave lens is reflected by the reflection surface of the reflection element associated with the concave lens and is collected toward the lens region of the liquid crystal lens 34. The optical signal having entered the lens region of the liquid crystal lens 34 is collected toward the light receiving portion of the light receiving element 35 associated with the liquid crystal lens 34. The optical signal collected on the light receiving portion is received by the light receiving element 35. The optical signal received by the light receiving element 35 is decoded by the reception circuit 36.

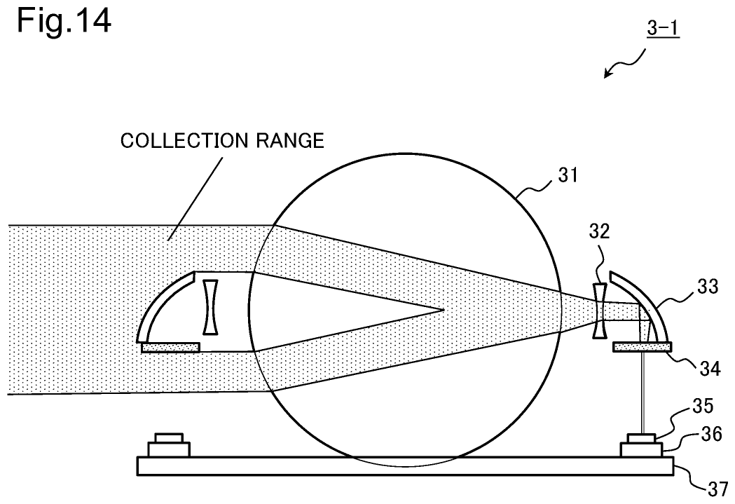

FIG. 14 is a conceptual view illustrating another example (reception device 3-1) of the state in which the spatial optical signal is collected toward the light receiving element 35. In FIG. 14, an example of the collection range of the spatial optical signal and the traveling range of the optical signal is indicated by hatching. Unlike the configurations in FIGS. 11 to 13, in the example of FIG. 14, the reflector 33 and the liquid crystal lens 34 are close to each other, and a distance between the liquid crystal lens 34 and the light receiving element 35 is long. In the example of FIG. 14, since the distance between the liquid crystal lens 34 and the light receiving element 35 is long, it is also possible to collect the optical signal toward the light receiving element associated with the adjacent reflection element. For example, the number of light receiving elements can be reduced by sharing the same light receiving element by a plurality of adjacent reflection elements.

As described above, the reception device of the present example embodiment includes the ball lens, the concave lens array, the reflector, the liquid crystal lenses, the light receiving element array, and the reception circuit. The ball lens, the concave lens array, the reflector, and the light receiving element array are included in the light receiving device. The ball lens is a spherical lens. The concave lens array has a structure in which the plurality of concave lenses are arranged in an annular form. The plurality of concave lenses included in the concave lens array are arranged in the light collecting region of the ball lens. The plurality of reflection elements are arranged in an annular form around the concave lens array. The reflector includes the plurality of reflection elements. The reflection element is arranged in association with any one of the plurality of concave lenses included in the concave lens array. The reflection element has the reflection surface that diffracts and reflects the optical signal collected by the concave lens. The liquid crystal lens is arranged between the reflection element and the light receiving element. The liquid crystal lens collects the optical signal diffracted and reflected by the reflection element toward the light receiving portion of the light receiving element. The light receiving element array includes the plurality of light receiving elements. The light receiving element is arranged in association with any one of the plurality of reflection elements included in the reflector. The light receiving element receives the optical signal collected by the liquid crystal lens. The reception circuit acquires a signal received by the light receiving device. The reception circuit decodes the acquired signal.

The reception device of the present example embodiment collects, by the ball lens, the spatial optical signal transmitted from a communication target. The optical signal collected by the ball lens is converted into a light flux close to parallel light by any one of the concave lenses included in the concave lens array. The optical signal having passed through the concave lens is collected on the reflection surface of the reflection element associated with the concave lens. The optical signal collected on the reflection surface of the reflection element is diffracted and reflected by the reflection surface and collected on the liquid crystal lens. The optical signal collected on the liquid crystal lens is collected on the light receiving portion of the light receiving element by the liquid crystal lens. The light receiving element receives the collected optical signal. The light receiving element converts the received optical signal into an electric signal. With the reception device of the present example embodiment, the spatial optical signal can be efficiently received by using the concave lens array and the reflector arranged around the ball lens. Further, with the reception device of the present example embodiment, a shift of collected light by the reflection element is corrected by the liquid crystal lens, and thus, light collection accuracy is improved.

### Fourth Example Embodiment

Next, a reception device according to a fourth example embodiment will be described with reference to the drawings. The reception device of the present example embodiment is different from the first to third example embodiments in that the light receiving element and the reception circuit have a structure separated from the support substrate. In the present example embodiment, unless otherwise specified, the spatial optical signal is regarded as parallel light because the spatial optical signal arrives from a sufficiently distant position. The drawings used in the description of the present example embodiment are conceptual and do not accurately depict an actual structure.

(Configuration)

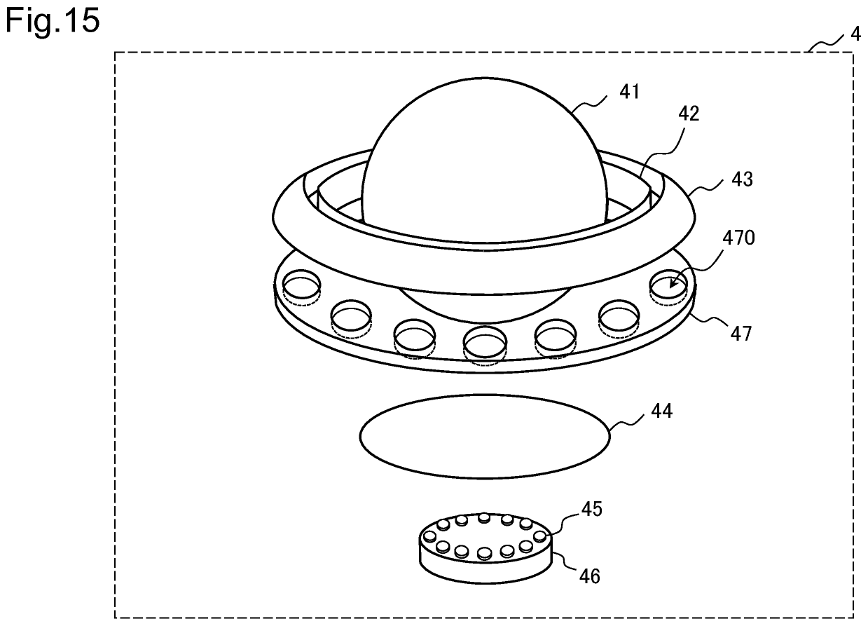

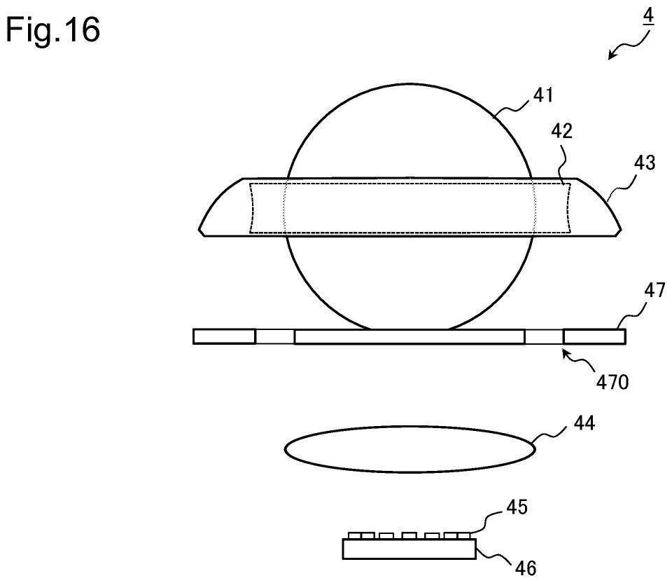

FIGS. 15 and 16 are conceptual views illustrating an example of a configuration of a reception device 4 according to the present example embodiment. The reception device 4 includes a ball lens 41, a concave lens array 42, a reflector 43, a condenser lens 44, a plurality of light receiving elements 45, a reception circuit 46, and a support substrate 47. The ball lens 41, the concave lens array 42, the reflector 43, the condenser lens 44, and the light receiving element 45 are included in a light receiving device. FIG. 15 is an oblique view of the light receiving device as viewed obliquely from above. FIG. 16 is a side view of the light receiving device as viewed from the lateral direction.

A positional relationship among the ball lens 41, the concave lens array 42, the reflector 43, and the condenser lens 44 is fixed by a support (not illustrated). The ball lens 41, the concave lens array 42, and the reflector 43 are arranged over the support substrate 47. The condenser lens 44 is arranged below the support substrate 47. A positional relationship between the condenser lens 44 and the support substrate 47 changes according to a state in which the light receiving device is arranged. Openings 470 are formed in the support substrate 47. The opening 470 is formed between each of a plurality of reflection elements included in the reflector 43 and the light receiving element 45 associated with the reflection element. FIG. 15 illustrates an example in which the opening 470 has a circular shape. The shape of the opening 470 is not limited to a circular shape. A position where the opening 470 is formed is not limited as long as the opening 470 is formed between the plurality of reflection elements and the light receiving element 45. For example, an annular opening 470 may be formed in the support substrate 47 in accordance with the shape of the reflector 43. In the present example embodiment, a support that fixes the positional relationship among the ball lens 41, the concave lens array 42, the reflector 43, and the condenser lens 44 is omitted. The reception circuit 46 is arranged below the support substrate. In the present example embodiment, the reception circuit 46 is implemented by a single common circuit for the plurality of light receiving elements 45.

The ball lens 41 has the same configuration as the ball lens 11 of the first example embodiment. The ball lens 41 collects the spatial optical signal arriving from the outside. The ball lens 41 collects the incident spatial optical signal. Light (also referred to as an optical signal) derived from the spatial optical signal collected by the ball lens 41 is collected toward a light collecting region of the ball lens 41.

The concave lens array 42 has the same configuration as the concave lens array 22 of the second example embodiment. The concave lens array 42 has a configuration in which a plurality of concave lenses are arranged in an annular form. The concave lens array 42 is arranged in a light collecting region including a light collecting point of the ball lens 41. The plurality of concave lenses included in the concave lens array 42 have a function similar to that of the concave lens 12 of the first example embodiment. The plurality of concave lenses included in the concave lens array 42 are arranged in an annular form around the ball lens 41. The plurality of concave lenses included in the concave lens array 42 may be integrated.

Each of the plurality of concave lenses is associated with one of a plurality of reflection elements included in the reflector 43. The optical signal collected by the ball lens 41 is incident on the concave lens included in the concave lens array 42. The concave lens converts the incident optical signal into a light flux close to parallel light. The optical signal having passed through the concave lens travels toward a reflection surface of the reflection element associated with the concave lens.

The reflector 43 has a configuration in which the plurality of reflection elements are arranged in an annular form. The reflector 43 includes the plurality of reflection elements. The plurality of reflection elements included in the reflector 43 has a function similar to that of the reflection element 13 of the first example embodiment. The plurality of reflection elements included in the reflector 43 are arranged in an annular form around the ball lens 41. Each of the plurality of reflection elements is associated with any one of the plurality of concave lenses included in the concave lens array 42. Each of the plurality of reflection elements is associated with any one of the plurality of optical elements. The reflection element is arranged downstream of the associated concave lens. The plurality of reflection elements included in the reflector 43 may be integrated.

The reflection element has the reflection surface that diffracts and reflects the incident light. For example, the reflection element is implemented by a reflection type diffractive optical element (DOE). The reflection surface of the reflection element is oriented obliquely with respect to a principal surface of the associated concave lens and a light receiving portion of the light receiving element 45 positioned downstream. The optical signal collected by the concave lens is incident on the reflection surface of the reflection element. The optical signal incident on the reflection surface of the reflection element is collected toward a light receiving portion of the associated light receiving element 45.

The condenser lens 44 is arranged below the support substrate 47. The condenser lens 44 is arranged between the reflector 43 and the light receiving elements 45. The condenser lens 44 is an optical lens. A principal surface of the condenser lens 44 is arranged between the support substrate 47 and the reception circuit 46 in parallel to main surfaces of the support substrate 47 and the reception circuit 46. The optical signal reflected by the reflection element of the reflector 43 and passing through the opening 470 of the support substrate 47 is incident on the condenser lens 44. The condenser lens 44 collects the incident optical signal toward the light receiving portion of the light receiving element 45 associated with the reflection element.

In a case where the spatial optical signal is a near-infrared ray, a material that transmits near-infrared rays is used for the condenser lens 44. For example, in a case of receiving the spatial optical signal in the near-infrared region of about 1.5 μm, a material such as silicon can be applied to the condenser lens 44 in addition to glass, crystal, resin, and the like. In a case where the spatial optical signal is an infrared ray, a material that transmits infrared rays is used for the condenser lens 44. For example, in a case where the spatial optical signal is an infrared ray, a silicon-based material, a germanium-based material, or a chalcogenide-based material can be applied to the condenser lens 44. The material of the condenser lens 44 is not limited as long as light of a wavelength region of the spatial optical signal can be transmitted/refracted. The material of the condenser lens 44 may be appropriately selected according to a required refractive index.

The light receiving element 45 has the same configuration as the light receiving element 15 of the first example embodiment. The plurality of light receiving elements 45 are arranged on an upper surface of a substrate of the reception circuit 46. The plurality of light receiving elements 45 are included in a light receiving element array. In the example of FIGS. 15 and 16, the plurality of light receiving elements 45 are arranged in an annular form. Each of the plurality of light receiving elements 45 is associated with any one of the plurality of openings 470 formed in the support substrate 47. The light receiving element 45 includes the light receiving portion that receives an optical signal. The light receiving portion of the light receiving element 45 is oriented toward an emission surface of the condenser lens 44. The optical signal collected by the condenser lens 44 is incident on the light receiving portion of the light receiving element 45. The light receiving element 45 receives the optical signal incident on the light receiving portion. The light receiving element 45 converts the received optical signal into an electric signal. The converted electric signal is output to the reception circuit 46.

The reception circuit 46 is implemented by a single common circuit for the plurality of light receiving elements 45. In the example of FIGS. 15 and 16, the reception circuit 46 is mounted on a disk-shaped substrate. The plurality of light receiving elements 45 are arranged in an annular form on an upper surface of the substrate on which the reception circuit 46 is mounted. The reception circuit 46 receives the electric signal output from the light receiving element 45. The reception circuit 46 decodes the received electric signal. The reception circuit 46 outputs the decoded signal. The signal decoded by the reception circuit 46 is used for any purpose. The use of the signal decoded by the reception circuit 46 is not particularly limited.

The support substrate 47 is a substrate that supports the ball lens 41, the concave lens array 42, the reflector 43, and the condenser lens 44. The support that fixes the ball lens 41, the concave lens array 42, the reflector 43, and the condenser lens 44 to the support substrate 47 is omitted. The condenser lens 44 may be supported by a substrate or the like other than the support substrate 47. The material and shape of the support substrate 47 are not particularly limited.

A plurality of openings 470 are formed in the support substrate 47. The opening 470 is formed between any one of the reflection elements included in the reflector 43 and the light receiving element 45 associated with the reflection element. The opening 470 is formed in a shape and a size with which the optical signal reflected by the reflection element can reach the light receiving portion of the light receiving element 45 associated with the reflection element. The optical signal reflected by the reflection element passes through the opening 470 and is collected by the condenser lens 44. The optical signal collected by the condenser lens 44 travels toward the light receiving portion of the light receiving element 45 associated with the reflection element.

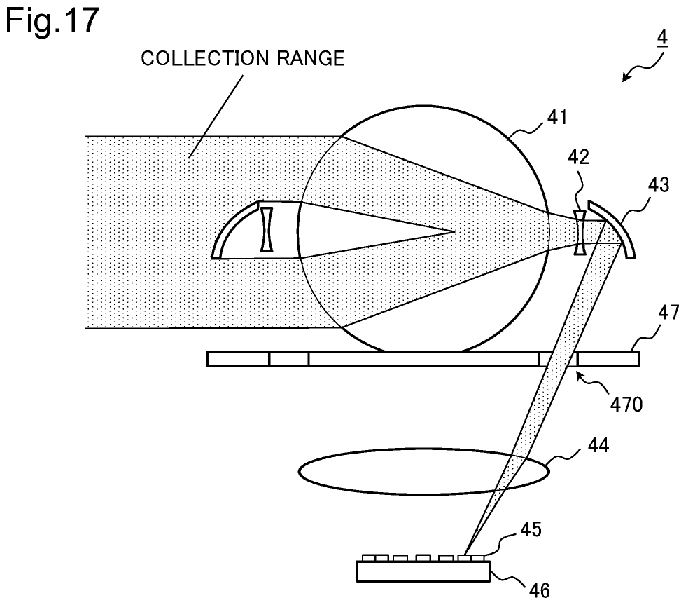

FIG. 17 is a conceptual view illustrating a state in which the spatial optical signal is collected toward the light receiving element 45. In FIG. 17, an example of the collection range of the spatial optical signal and the traveling range of the optical signal is indicated by hatching. The spatial optical signal arriving at the ball lens 41 is collected by the ball lens 41. The optical signal collected by the ball lens 41 is collected toward any one of the concave lenses included in the concave lens array 42. The optical signal that has reached the concave lens is converted into a light flux close to parallel light. The optical signal collected by the concave lens is reflected by the reflection surface of the reflection element associated with the concave lens and is collected toward the opening 470 of the support substrate 47. The optical signal having passed through the opening 470 of the support substrate 47 is collected by the condenser lens 44. The optical signal collected by the condenser lens 44 is collected toward the light receiving portion of the light receiving element 45 associated with the reflection element. The optical signal collected on the light receiving portion is received by the light receiving element 45. The optical signal received by the light receiving element 45 is decoded by the reception circuit 46.

### Modified Example

Next, two modified examples of the reception device 4 of the present example embodiment will be described. The following modified examples are merely examples, and do not limit variations of the reception device 4.

### First Modified Example

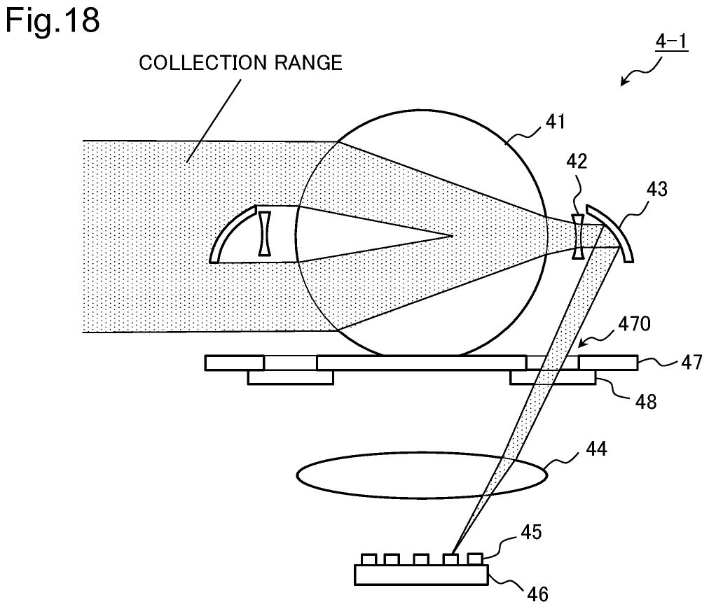

FIG. 18 is a conceptual view illustrating an example of a configuration of a reception device 4-1 according to a first modified example. FIG. 18 is a cross-sectional view of the reception device 4-1 as viewed from the side. The reception device 4-1 of the present modified example has a configuration in which a liquid crystal lens 48 is added to the configurations in FIGS. 15 and 16. A configuration other than the liquid crystal lens 48 included in the reception device 4-1 is similar to the configuration in FIGS. 15 and 16. In the present modified example, it is assumed that the reception circuit 46 has a function of controlling the liquid crystal lens 48. A control circuit (not illustrated) that controls the liquid crystal lens 48 may be included in the reception device 4-1.

The liquid crystal lens 48 is associated with any one of the plurality of openings 470 formed in the support substrate 47. The liquid crystal lens 48 may be arranged at each of all the openings 470, or may be arranged at any one of the plurality of openings 470. In the example of FIG. 18, the liquid crystal lens 48 is arranged under the support substrate 47. The liquid crystal lens 48 may be arranged over the support substrate 47. The liquid crystal lens 48 may be arranged inside the associated opening 470. The liquid crystal lens 48 may be arranged in association with some of the plurality of light receiving elements 45. The liquid crystal lens 48 has the same configuration as the liquid crystal lens 34 of the third example embodiment.

The optical signal reflected by the reflection element included in the reflector 43 is incident on the liquid crystal lens 48. The liquid crystal lens 48 diffracts the optical signal incident on the lens region from an incident surface under the control of the reception circuit 46. The optical signal diffracted by the liquid crystal lens 48 is emitted from an emission surface of the liquid crystal lens 48 toward the condenser lens 44. That is, an emission direction of the optical signal incident on the liquid crystal lens 48 is controlled by the reception circuit 46, and the optical signal is focused toward the condenser lens 44. The optical signal emitted from the liquid crystal lens 48 is collected by the condenser lens 44 and received by the light receiving portion of the light receiving element 45.

In the present modified example, the liquid crystal lens 48 controls the direction of the optical signal reflected by the reflection element of the reflector 43. According to the present modified example, as the direction of the optical signal is controlled by the liquid crystal lens 48, the optical signal can be collected at a desired position. Therefore, according to the present modified example, the number of light receiving elements 45 can be smaller than those in the configurations in FIGS. 15 and 16.

### Second Modified Example

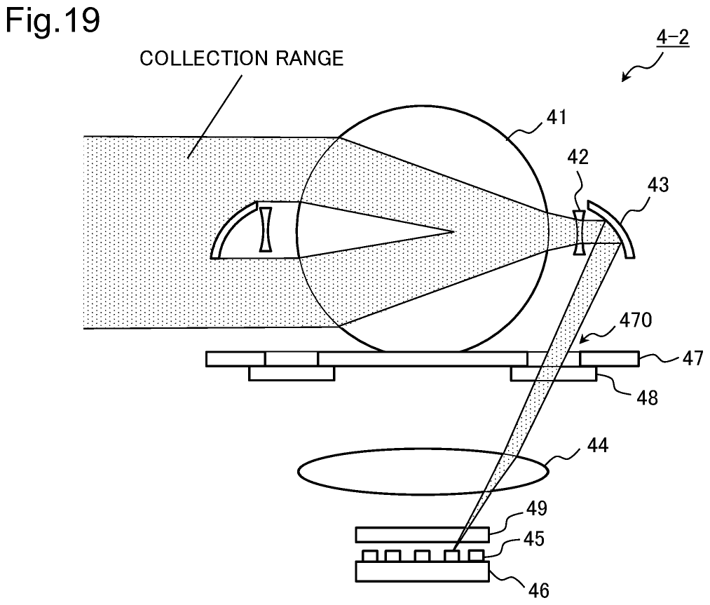

FIG. 19 is a conceptual view illustrating an example of a configuration of a reception device 4-2 according to a second modified example. FIG. 19 is a cross-sectional view of the reception device 4-2 as viewed from the side. The reception device 4-2 of the present modified example has a configuration in which a second harmonic generator 49 is added to the configuration of the first modified example (FIG. 18). A configuration other than the second harmonic generator 49 included in the reception device 4-2 is similar to the configuration of the first modified example (FIG. 18).

The second harmonic generator 49 (also referred to as a wavelength converter) is arranged between the condenser lens 44 and the plurality of light receiving elements 45. In the example of FIG. 19, the second harmonic generator 49 is arranged above the substrate of reception circuit 46 on which the plurality of light receiving elements 45 are arranged. The second harmonic generator 49 includes a nonlinear optical element that halves a wavelength of the incident optical signal. The second harmonic generator 49 converts the wavelength of the incident optical signal into ½ of the wavelength of the optical signal. For example, the second harmonic generator 49 converts a wavelength of an optical signal of 1.5 μm into 750 nm. In a case of light having a wavelength of 750 nm, a silicon-based photodiode that is cheaper than that for light having a wavelength of 1.5 μm can be applied as the light receiving element 45.

In the present modified example, the wavelength of the optical signal received by the light receiving element 45 is converted into a half of a wavelength of the spatial optical signal by the second harmonic generator 49. Therefore, according to the present modified example, an inexpensive photodiode can be applied to the light receiving element 45. A plurality of second harmonic generators 49 may be arranged. For example, if a third harmonic generator is used instead of the second harmonic generator 49, the wavelength of the optical signal can be converted to ⅓.

As described above, the reception device according to the present example embodiment includes the ball lens, the concave lens array, the reflector, the condenser lens, the light receiving element array, the reception circuit, and the support substrate. The support substrate supports the ball lens, the concave lens array, and the reflector. The support substrate has the opening formed between each of the plurality of reflection elements included in the reflector and the light receiving element associated with the reflection element. The ball lens, the concave lens array, the reflector, and the light receiving element array are included in the light receiving device. The ball lens is a spherical lens. The concave lens array has a structure in which the plurality of concave lenses are arranged in an annular form. The plurality of concave lenses included in the concave lens array are arranged in the light collecting region of the ball lens. The plurality of reflection elements are arranged in an annular form around the concave lens array. The reflector includes the plurality of reflection elements. The reflection element is arranged in association with any one of the plurality of concave lenses included in the concave lens array. The reflection element has the reflection surface that diffracts and reflects the optical signal collected by the concave lens. The optical signal reflected by the reflection element passes through the opening of the support substrate and is collected toward the condenser lens. The condenser lens is arranged below the support substrate. The condenser lens collects the optical signal diffracted and reflected by the reflection surface of each of the plurality of reflection elements included in the reflector toward the light receiving element associated with the reflection element. The light receiving element array includes the plurality of light receiving elements. The light receiving element is arranged in association with any one of the plurality of reflection elements included in the reflector. The light receiving element receives the optical signal collected by the condenser lens. The reception circuit acquires a signal received by the light receiving device. The reception circuit decodes the acquired signal.

The reception device of the present example embodiment collects, by the ball lens, the spatial optical signal transmitted from a communication target. The optical signal collected by the ball lens is converted into a light flux close to parallel light by any one of the concave lenses included in the concave lens array. The optical signal having passed through the concave lens is collected on the reflection surface of the reflection element associated with the concave lens. The optical signal collected on the reflection surface of the reflection element is diffracted and reflected by the reflection surface and is collected toward the condenser lens. The condenser lens collects the collected optical signal on the light receiving portion of the light receiving element. The light receiving element receives the collected optical signal. The light receiving element converts the received optical signal into an electric signal. With the reception device of the present example embodiment, the spatial optical signal can be efficiently received by using the concave lens array and the reflector arranged around the ball lens. Furthermore, with the reception device of the present example embodiment, the distance between the reflector and the light receiving element can be long, and thus, the number of light receiving elements can be reduced by narrowing a range in which the optical signal is collected.

In one aspect of the present example embodiment, the liquid crystal lens is arranged at the opening of the support substrate. According to this aspect, the optical signal can be collected in a narrower range by direction control for the optical signal by the liquid crystal lens. Therefore, according to this aspect, the number of light receiving elements can be further reduced.

In one aspect of the present example embodiment, the wavelength converter that converts the wavelength of the optical signal is arranged between the condenser lens and the light receiving element array. According to this aspect, the wavelength of the optical signal can be converted by the wavelength converter, and thus, an inexpensive light receiving element can be applied.

### Fifth Example Embodiment

Next, a communication device according to a fifth example embodiment will be described with reference to the drawings. The communication device of the present example embodiment has a configuration in which a reception device and a transmission device are combined. The reception device has the configuration of any one of the first to fourth example embodiments. The transmission device transmits a spatial optical signal. Hereinafter, an example of the transmission device including a transmission device that includes a phase-modulation-type spatial light modulator will be described. The communication device of the present example embodiment may include a transmission device having a light transmission function that is not a phase-modulation-type spatial light modulator.

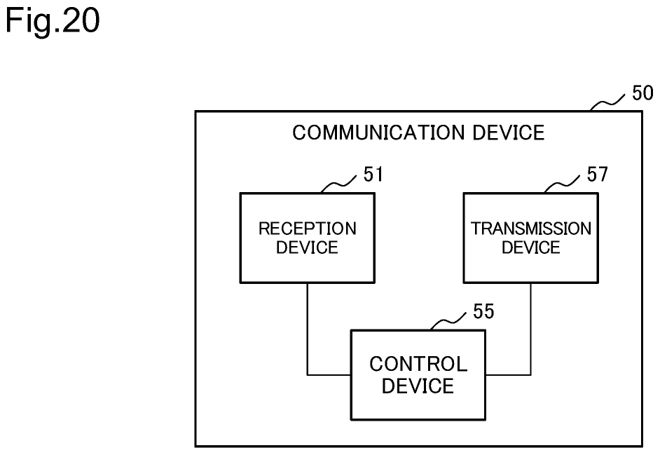

FIG. 20 is a conceptual diagram illustrating an example of a configuration of a communication device 50 according to the present example embodiment. The communication device 50 includes a reception device 51, a control device 55, and a transmission device 57. The communication device 50 transmits and receives a spatial optical signal to and from an external communication target. Therefore, an opening or a window for transmitting and receiving a spatial optical signal is formed in the communication device 50.

The reception device 51 is the reception device of the first example embodiment. The reception device 51 receives a spatial optical signal transmitted from a communication target (not illustrated). The reception device 51 converts the received spatial optical signal into an electric signal. The reception device 51 outputs the converted electric signal to the control device 55.

The control device 55 acquires a signal output from the reception device 51. The control device 55 executes processing according to the acquired signal. The processing executed by the control device 55 is not particularly limited. The control device 55 outputs a control signal for transmitting an optical signal associated to the executed processing to the transmission device 57. For example, the control device 55 executes processing based on a predetermined condition according to information included in the signal received by the reception device 51. For example, the control device 55 executes processing designated by an administrator or the like of the communication device 50 according to the information included in the signal received by the reception device 51.

The transmission device 57 acquires the control signal from the control device 55. The transmission device 57 projects a spatial optical signal relevant to the control signal. The spatial optical signal projected from the transmission device 57 is received by a communication target (not illustrated) of a transmission destination of the spatial optical signal. For example, the transmission device 57 includes a phase-modulation-type spatial light modulator. The transmission device 57 may have a light transmission function that is not a phase-modulation-type spatial light modulator.

[Transmission Device]

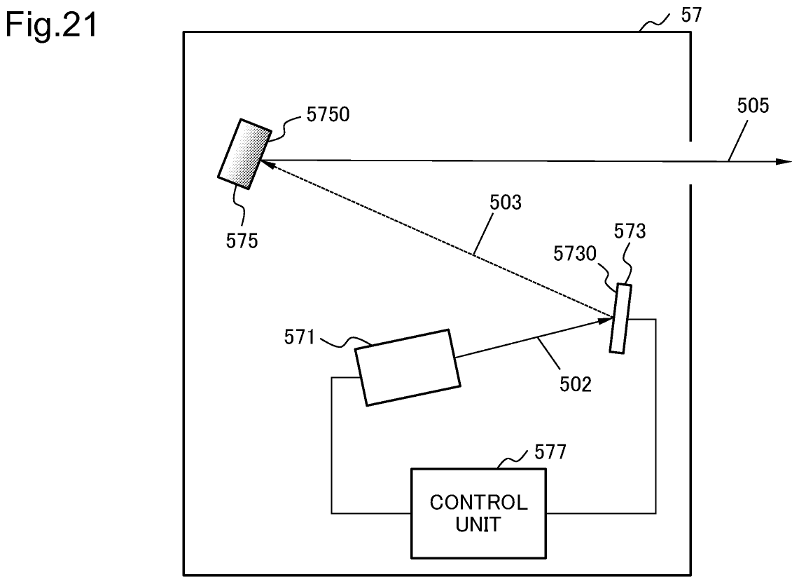

FIG. 21 is a conceptual diagram illustrating an example of a configuration of the transmission device 57. The transmission device 57 includes a light source 571, a spatial light modulator 573, a curved mirror 575, and a control unit 577. FIG. 21 is a side view of an internal configuration of the transmission device 57 as viewed from the lateral direction. FIG. 21 is a conceptual view and does not accurately represent a positional relationship between the components, a traveling direction of light, and the like.

The light source 571 emits laser light in a predetermined wavelength band under the control of the control unit 577. The wavelength of the laser light emitted from the light source 571 is not particularly limited and may be selected depending on the use. For example, the light source 571 emits laser light in a visible or infrared wavelength band. For example, in a case of a near-infrared ray of 800 to 900 nanometers (nm), since a laser class can be increased, sensitivity can be improved by about one digit as compared with other wavelength bands. For example, a high-output laser light source can be used for an infrared ray in a wavelength band of 1.55 micrometers (μm). As a laser light source of an infrared ray in a wavelength band of 1.55 μm, an aluminum gallium arsenide phosphide (AlGaAsP)-based laser light source, an indium gallium arsenide (InGaAs)-based laser light source, or the like can be used. The longer the wavelength of the laser light is, the larger the diffraction angle can be made and the higher the energy can be set. The light source 571 includes a lens that expands laser light in accordance with a size of a modulation region set in a modulation unit 5730 of the spatial light modulator 573. The light source 571 emits light 502 expanded by the lens. The light 502 emitted from the light source 571 travels toward the modulation unit 5730 of the spatial light modulator 573.

The spatial light modulator 573 includes the modulation unit 5730. The modulation region is set in the modulation unit 5730. In the modulation region of the modulation unit 5730, a pattern (also referred to as a phase image) associated to an image displayed by projected light 505 is set under the control of the control unit 577. The modulation unit 5730 is irradiated with the light 502 emitted from the light source 571. The light 502 incident on the modulation unit 5730 is modulated according to the pattern (phase image) set in the modulation unit 5730. Modulated light 503 modulated by the modulation unit 5730 travels toward a reflection surface 5750 of the curved mirror 575.

For example, the spatial light modulator 573 is implemented by a spatial light modulator using ferroelectric liquid crystal, homogeneous liquid crystal, vertical alignment liquid crystal, or the like. For example, the spatial light modulator 573 can be implemented by liquid crystal on silicon (LCOS). The spatial light modulator 573 may be implemented by a micro electro mechanical system (MEMS). In the phase-modulation-type spatial light modulator 573, energy can be concentrated on the image by operating in such a way as to sequentially switch a portion on which the projected light 505 is to be projected. Therefore, in a case of using the phase-modulation-type spatial light modulator 573, if an output of the light source 571 is the same, the image can be displayed brighter as compared with those in a case of using other methods.

The modulation region of modulation unit 5730 is divided into a plurality of regions (also referred to as tiling). For example, the modulation region of the modulation unit 5730 is divided into rectangular regions (also referred to as tiles) having a desired aspect ratio. The phase image is assigned to each of the plurality of tiles set in the modulation region of the modulation unit 5730. Each of the plurality of tiles includes a plurality of pixels. The phase image associated to the projected image is set for each of the plurality of tiles. The phase images set for the plurality of tiles may be the same or different.

The phase image is tiled for each of the plurality of tiles assigned to the modulation region of the modulation unit 5730. For example, a phase image generated in advance is set for each of the plurality of tiles. When the modulation unit 5730 is irradiated with the light 502 in a state where the phase images are set for the plurality of tiles, the modulated light 503 that forms an image associated to the phase image of each tile is emitted. As the number of tiles set in the modulation unit 5730 increases, a clear image can be displayed. However, when the number of pixels of each tile decreases, the resolution decreases. Therefore, the size and number of tiles set in the modulation region of the modulation unit 5730 are set depending on the use.

The curved mirror 575 is a reflecting mirror having the curved reflection surface 5750. The reflection surface 5750 of the curved mirror 575 has a curvature based on a projection angle of the projected light 505. The reflection surface 5750 of the curved mirror 575 is only required to be a curved surface. In the example of FIG. 17, the reflection surface 5750 of the curved mirror 575 has a shape of a side surface of a cylinder. For example, the reflection surface 5750 of the curved mirror 575 may be a free-form surface or a spherical surface. For example, the reflection surface 5750 of the curved mirror 575 may have a shape in which a plurality of curved surfaces are combined, instead of a single curved surface. For example, the reflection surface 5750 of the curved mirror 575 may have a shape in which a curved surface and a flat surface are combined.

The curved mirror 575 is arranged with the reflection surface 5750 facing the modulation unit 5730 of the spatial light modulator 573. The curved mirror 575 is arranged on an optical path of the modulated light 503. The reflection surface 5750 is irradiated with the modulated light 503 modulated by the modulation unit 5730. The light (projected light 505) reflected by the reflection surface 5750 is expanded at an expansion ratio based on the curvature of the reflection surface 5750. In the example of FIG. 21, the projected light 505 is expanded in a horizontal direction (a direction perpendicular to a plane of FIG. 21) according to a curvature of an irradiation range of the modulated light 503 on the reflection surface 5750 of the curved mirror 575. The projected light 505 is also expanded in a vertical direction (a top-bottom direction on the plane of FIG. 21) as a distance from the transmission device 57 increases.

For example, a shield (not illustrated) may be arranged between the spatial light modulator 573 and the curved mirror 575. That is, the shield may be arranged on an optical path of the modulated light 503 modulated by the modulation unit 5730 of the spatial light modulator 573. The shield is a frame that blocks unnecessary light components included in the modulated light 503 and defines an outer edge of a display region of the projected light 505. For example, the shield is an aperture. In the aperture, a slit-shaped opening is formed at a portion through which light for forming a desired image passes. The shield passes light that forms a desired image and blocks unnecessary light components. For example, the shield blocks 0th-order light or a ghost image included in the modulated light 503. A detail description of the shield will be omitted.

The transmission device 57 may include a projection optical system including a Fourier transform lens, a projection lens, and the like instead of the curved mirror 575. The transmission device 57 may be configured to directly project the light modulated by the modulation unit 5730 of the spatial light modulator 573 without including the curved mirror 575 or the projection optical system.

The control unit 577 controls the light source 571 and the spatial light modulator 573. For example, the control unit 577 is implemented by a microcomputer including a processor and a memory. The control unit 577 sets a phase image associated to the projected image in the modulation unit 5730 according to the aspect ratio of tiling set in the modulation unit 5730 of the spatial light modulator 573. For example, the control unit 577 sets, in the modulation unit 5730, a phase image associated to an image for the use such as image display, communication, or distance measurement. The phase image of the projected image may be stored in advance in a storage unit (not illustrated). The shape and size of the projected image are not particularly limited.

The control unit 577 controls the spatial light modulator 573 in such a way that a parameter that determines a difference between a phase of the light 502 emitted to the modulation unit 5730 of the spatial light modulator 573 and a phase of the modulated light 503 reflected by the modulation unit 5730 changes. For example, the parameter is a value related to optical characteristics such as a refractive index and an optical path length. For example, the control unit 577 adjusts the refractive index of the modulation unit 5730 by changing a voltage applied to the modulation unit 5730 of the spatial light modulator 573. A phase distribution of the light 502 emitted to the modulation unit 5730 of the phase-modulation-type spatial light modulator 573 is modulated according to the optical characteristics of the modulation unit 5730. A method for driving the spatial light modulator 573 by the control unit 577 is determined according to a modulation scheme of the spatial light modulator 573.

The control unit 577 drives the light source 571 in a state where the phase image associated to the image to be displayed is set in the modulation unit 5730. As a result, the light 502 emitted from the light source 571 is emitted to the modulation unit 5730 of the spatial light modulator 573 at a timing at which the phase image is set in the modulation unit 5730 of the spatial light modulator 573. The light 502 emitted to the modulation unit 5730 of the spatial light modulator 573 is modulated by the modulation unit 5730 of the spatial light modulator 573. The modulated light 503 modulated by the modulation unit 5730 of the spatial light modulator 573 is emitted toward the reflection surface 5750 of the curved mirror 575.

For example, the curvature of the reflection surface 5750 of the curved mirror 575 included in the transmission device 57 and a distance between the spatial light modulator 573 and the curved mirror 575 are adjusted, and a projection angle of the projected light 505 is set to 180 degrees. By using two transmission devices 57 configured as described above, the projection angle of the projected light 505 can be set to 360 degrees. If a part of the modulated light 503 is reflected by a plane mirror or the like inside the transmission device 57 so that the projected light 505 is projected in two directions, the projection angle of the projected light 505 can be set to 360 degrees. For example, the transmission device 57 configured to project the projected light in a direction of 360 degrees and the reception device 51 configured to receive the spatial optical signal arriving from a direction of 360 degrees are combined. With such a configuration, it is possible to implement a communication device that transmits the spatial optical signal in a direction of 360 degrees and receives the spatial optical signal arriving from a direction of 360 degrees.

[Communication Device]

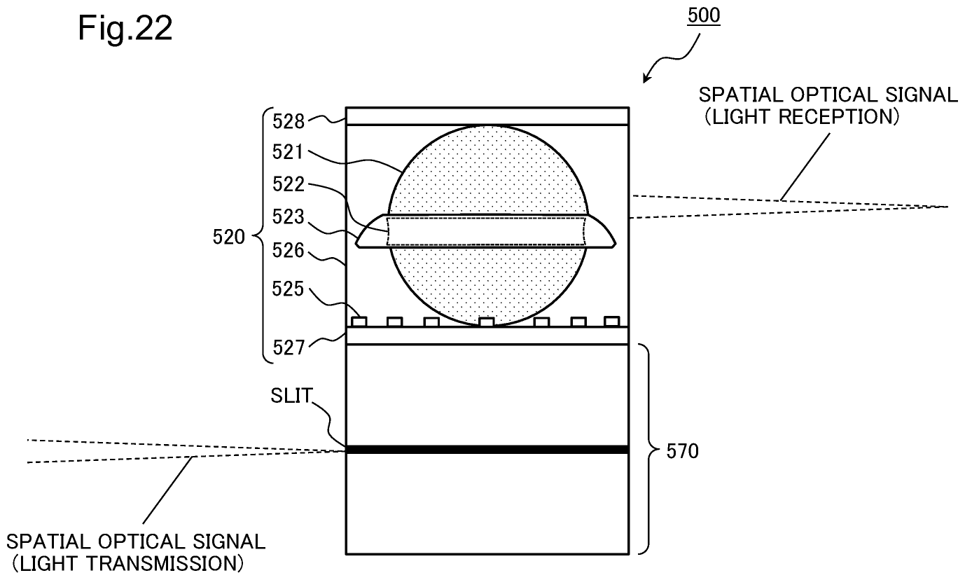

FIG. 22 is a conceptual diagram illustrating an example (communication device 500) of the communication device 50. The communication device 500 includes a receiver 520, a transmitter 570, and a control device (not illustrated). In FIG. 22, a reception circuit and a control device are omitted. The communication device 500 has a configuration in which the receiver 520 having a cylindrical outer shape and the transmitter 570 are combined.

The receiver 520 includes a ball lens 521, a concave lens array 522, a reflector 523, a plurality of light receiving elements 525, a color filter 526, a support substrate 527, and a lid 528. The ball lens 521 has the same configuration as the ball lens 11 of the first example embodiment. Upper and lower portions of the ball lens 521 are sandwiched between the lid 528 and the support substrate 527. Since the upper and lower portions of the ball lens 521 are not used for transmission and reception of the spatial optical signal, the upper and lower portions of the ball lens 521 may be processed into a planar shape in such a way as to be easily sandwiched between the lid 528 and the support substrate 527. The concave lens array 522 has the same configuration as the concave lens array 22 of the second example embodiment. The reflector 523 has the same configuration as the reflector 23 of the second example embodiment. The plurality of light receiving elements 525 have the same configuration as the light receiving elements 15 of the first example embodiment. The plurality of light receiving elements 525 are connected to a communication device (not illustrated) and the transmitter 570.

The color filter 526 is arranged on a side surface of the cylindrical receiver 520. The color filter 526 removes unnecessary light and selectively transmits the spatial optical signal used for communication. The lid 528 and the support substrate 527 are arranged on upper and lower surfaces of the cylindrical receiver 520, respectively. The upper and lower sides of the ball lens 521 are sandwiched between the lid 528 and the support substrate 527. The annular reflector 523 is arranged around the ball lens 521. The spatial optical signal incident on the ball lens 521 through the color filter 526 is collected toward the concave lens array 522 by the ball lens 521. The optical signal collected on the concave lens array 522 travels toward the reflector 523. The optical signal reaching the reflector 523 is guided toward a light receiving portion of any one of the light receiving elements 525. The optical signal reaching the light receiving portion of the light receiving element 525 is received by the light receiving element 525. The control device (not illustrated) controls the transmitter 570 to transmit the spatial optical signal according to the optical signal received by the light receiving element 525.

The transmitter 570 can be implemented by the configuration (transmission device 57) in FIG. 21. The transmitter 570 is housed inside a cylindrical housing. A slit opened in accordance with a direction in which the spatial optical signal is transmitted by the transmitter 570 is formed in the cylindrical housing. For example, in a case where the transmitter 570 can transmit the spatial optical signal in a direction of 360 degrees, the slit is formed in a side surface of the housing of the transmitter 570 in accordance with the direction in which the spatial optical signal is transmitted.

### Application Example

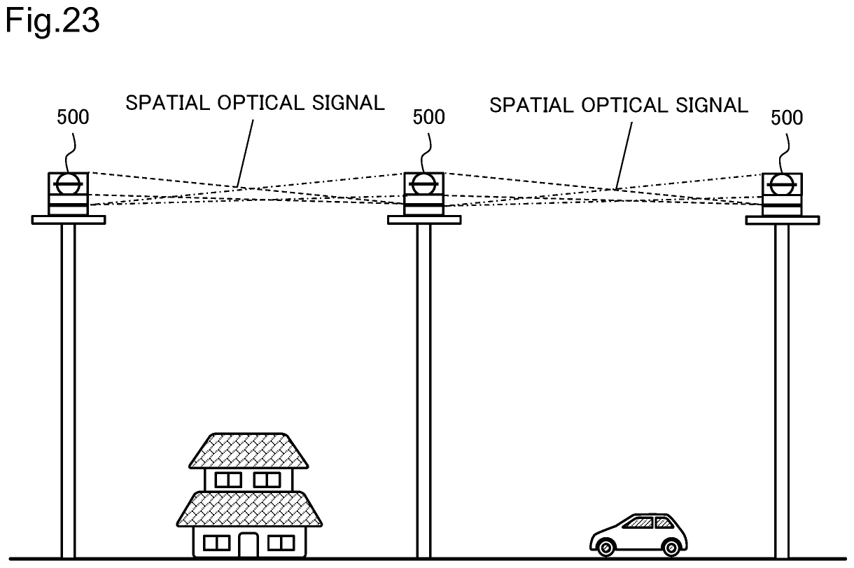

Next, an application example of the communication device 500 according to the present example embodiment will be described with reference to the drawings. FIG. 23 is a conceptual view for explaining the present application example. In the present application example, an example of a communication network (also referred to as a communication system) in which a plurality of communication devices 500 are arranged on upper portions (also referred to as on-pole spaces) of poles such as utility poles or streetlamps arranged in a town will be described.

There are few obstacles in the on-pole space. Therefore, the on-pole space is suitable for installing the communication device 500. If the communication device 500 is installed at the same height, an arrival direction of the spatial optical signal is limited to the horizontal direction. Therefore, a light receiving area of a light receiver included in the receiver 520 can be reduced, and the device can thus be simplified. A pair of communication devices 500 that transmit and receive the spatial optical signal is arranged in such a way that at least one communication device 500 receives the spatial optical signal transmitted from the other communication device 500. The pair of communication devices 500 may be arranged to transmit and receive the spatial optical signal to and from each other. In a case where the communication network for the spatial optical signal includes the plurality of communication devices 500, the communication device 500 positioned in the middle may be arranged to relay the spatial optical signal transmitted from one communication device 500 to another communication device 500.

According to the present application example, communication using the spatial optical signal can be performed among the plurality of communication devices 500 arranged in the on-pole space. For example, wireless communication may be performed between a wireless device or a base station installed in an automobile, a house, or the like and the communication device 500 according to communication between the communication devices 500 arranged in the on-pole spaces. For example, the communication device 500 may be configured to be connected to the Internet via a communication cable or the like installed on the pole.

As described above, the communication device according to the present example embodiment includes the reception device, the transmission device, and the control device. The reception device includes the ball lens, the concave lens, the reflection element, the light receiving elements, and the reception circuit. The ball lens, the concave lens, the reflection element, and the light receiving element are included in the light receiving device. The ball lens is a spherical lens. The concave lens is arranged in the light collecting region of the ball lens. The reflection element is arranged in association with the concave lens. The reflection element has the reflection surface that diffracts and reflects the optical signal collected by the concave lens. The light receiving element is arranged in association with the reflection element. The light receiving element receives the optical signal diffracted and reflected by the reflection surface of the reflection element. The reception circuit acquires a signal received by the light receiving device. The reception circuit decodes the acquired signal. The transmission device transmits a spatial optical signal. The control device acquires a signal based on the spatial optical signal from another communication device received by the reception device. The control device executes processing according to the acquired signal. The control device causes the transmission device to transmit the spatial optical signal associated to the executed processing.

The light receiving device included in the communication device of the present example embodiment collects the spatial optical signal transmitted from a communication target by the ball lens. The optical signal collected by the ball lens is converted into a light flux close to parallel light by the concave lens. The optical signal having passed through the concave lens is collected on the reflection surface of the reflection element. The optical signal collected on the reflection surface of the reflection element is diffracted and reflected by the reflection surface and collected on the light receiving portion of the light receiving element. The light receiving element receives the collected optical signal. The light receiving element converts the received optical signal into an electric signal. In the light receiving device of the present example embodiment, a direction in which the optical signal is received by the light receiving element can be greatly changed with respect to the arrival direction of the spatial optical signal by the reflection element. In the light receiving device of the present example embodiment, since there are few limitations on the position of the light receiving element with respect to the ball lens, the light receiving element can be arranged at a position where the optical signal can be efficiently received. Therefore, with the light receiving device of the present example embodiment, efficient communication with a communication target can be implemented according to the spatial optical signal that is efficiently received.

The communication system according to one aspect of the present example embodiment includes the plurality of communication devices described above. In the communication system, the plurality of communication devices are arranged to transmit and receive the spatial optical signal to and from each other. According to this aspect, it is possible to implement the communication network that transmits and receives the spatial optical signal.

### Sixth Example Embodiment

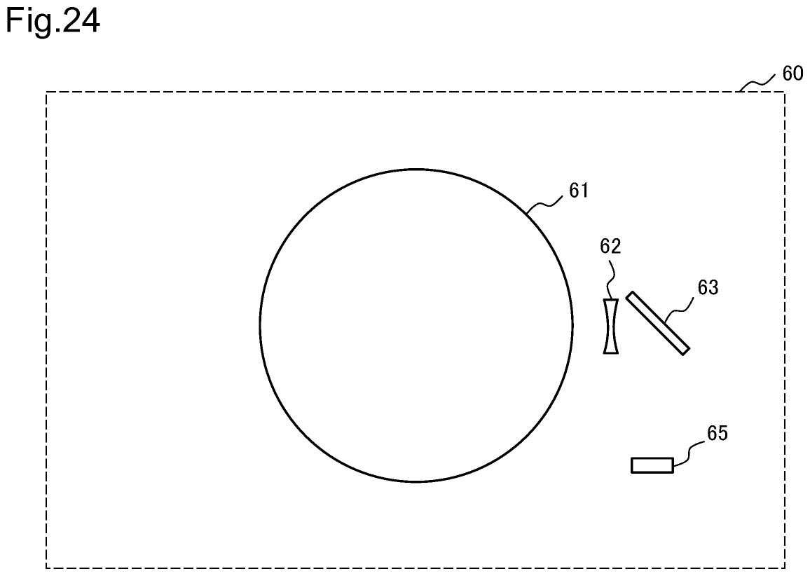

Next, a light receiving device according to a sixth example embodiment will be described with reference to the drawings. The light receiving device of the present example embodiment has a configuration in which the light receiving devices of the first to fourth example embodiments are simplified. FIG. 24 is a conceptual diagram illustrating an example of a configuration of a light receiving device 60 according to the present example embodiment. FIG. 24 is a side view of the light receiving device 60 as viewed from the side.

The light receiving device 60 includes a ball lens 61, a concave lens 62, a reflection element 63, and a light receiving element 65. The ball lens 61 is a spherical lens. The concave lens 62 is arranged in a light collecting region of the ball lens 61. The reflection element 63 is arranged in association with the concave lens 62. The reflection element 63 has a reflection surface that diffracts and reflects the optical signal collected by the concave lens 62. The light receiving element 65 is arranged in association with the reflection element 63. The light receiving element 65 receives the optical signal diffracted and reflected by the reflection surface of the reflection element 63.

As described above, the light receiving device of the present example embodiment collects the spatial optical signal transmitted from a communication target by the ball lens. The optical signal collected by the ball lens is converted into a light flux close to parallel light by the concave lens. The optical signal having passed through the concave lens is collected on the reflection surface of the reflection element. The optical signal collected on the reflection surface of the reflection element is diffracted and reflected by the reflection surface and collected on the light receiving portion of the light receiving element. The light receiving element receives the collected optical signal. The light receiving element converts the received optical signal into an electric signal. In the light receiving device of the present example embodiment, a direction in which the optical signal is received by the light receiving element can be greatly changed with respect to the arrival direction of the spatial optical signal by the reflection element. In the light receiving device of the present example embodiment, since there are few limitations on the position of the light receiving element with respect to the ball lens, the light receiving element can be arranged at a position where the optical signal can be efficiently received. Therefore, with the light receiving device of the present example embodiment, the spatial optical signal can be efficiently received.

(Hardware)

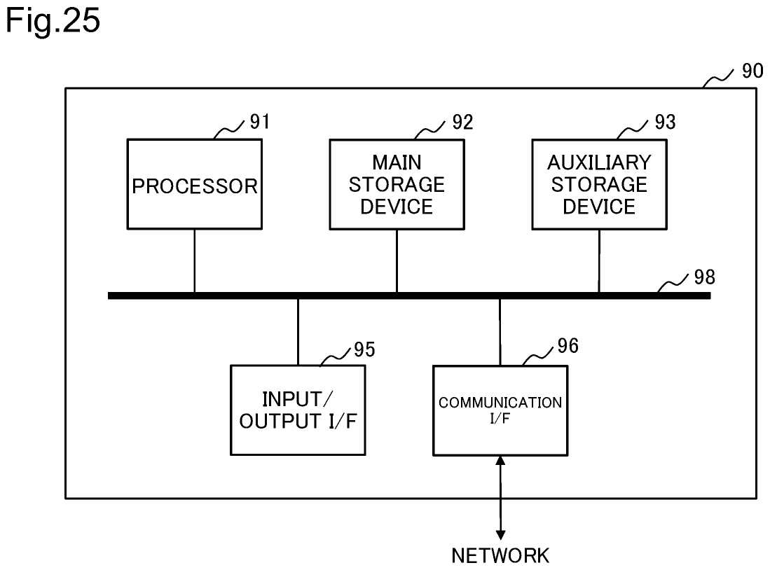

Here, a hardware configuration for executing control and processing according to each example embodiment of the present disclosure will be described using an information processing device 90 (computer) in FIG. 25 as an example. The information processing device 90 in FIG. 25 is a configuration example for executing the control and processing according to each example embodiment, and does not limit the scope of the present disclosure.

As illustrated in FIG. 25, the information processing device 90 includes a processor 91, a main storage device 92, an auxiliary storage device 93, an input/output interface 95, and a communication interface 96. In FIG. 25, the interface is abbreviated as an I/F. The processor 91, the main storage device 92, the auxiliary storage device 93, the input/output interface 95, and the communication interface 96 are data-communicably connected to each other via a bus 98. In addition, the processor 91, the main storage device 92, the auxiliary storage device 93, and the input/output interface 95 are connected to a network such as the Internet or an intranet via the communication interface 96.

The processor 91 loads a program (command) stored in the auxiliary storage device 93 or the like to the main storage device 92. For example, the program is a software program for executing the control and processing according to each example embodiment. The processor 91 executes the program loaded to the main storage device 92. The processor 91 executes the program to execute the control and processing according to each example embodiment.

The main storage device 92 has a region to which the program is loaded. A program stored in the auxiliary storage device 93 or the like is loaded to the main storage device 92 by the processor 91. The main storage device 92 may be implemented by a volatile memory such as a dynamic random access memory (DRAM). A nonvolatile memory such as a magneto resistive random access memory (MRAM) may be configured and added as the main storage device 92.

The auxiliary storage device 93 stores various pieces of data such as programs. The auxiliary storage device 93 is implemented by a local disk such as a hard disk or a flash memory. Various pieces of data may be stored in the main storage device 92, and the auxiliary storage device 93 may be omitted.

The input/output interface 95 is an interface for connecting the information processing device 90 and a peripheral device based on a standard or a specification. The communication interface 96 is an interface for connecting to an external system or device through a network such as the Internet or an intranet based on a protocol or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. In a case where a touch panel is used as the input device, a screen having a touch panel function serves as an interface. The processor 91 and the input device are connected via the input/output interface 95.

The information processing device 90 may be provided with a display device for displaying information. In a case where the display device is provided, the information processing device 90 includes a display control device (not illustrated) for controlling display of the display device. The information processing device 90 and the display device may be connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via the input/output interface 95.

An example of the hardware configuration for executing the control and processing according to each example embodiment of the present invention has been described above. The hardware configuration in FIG. 25 is an example of the hardware configuration for executing the control and processing according to each example embodiment, and does not limit the scope of the present invention. In addition, a program for causing a computer to execute the control and processing according to each example embodiment also falls within the scope of the present invention.

Further, a program recording medium having the program according to each example embodiment recorded therein also falls within the scope of the present invention. The recording medium can be implemented by, for example, an optical recording medium such as a compact disc (CD) or a digital versatile disc (DVD). The recording medium may be implemented by a semiconductor recording medium such as a universal serial bus (USB) memory or a secure digital (SD) card. Furthermore, the recording medium may be implemented by a magnetic recording medium such as a flexible disk, or another recording medium. In a case where the program executed by the processor is recorded in a recording medium, the recording medium corresponds to the program recording medium.

Any combination of the components of each example embodiment is possible. The components of each example embodiment may be implemented by software. The components of each example embodiment may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A light receiving device comprising:
a ball lens;
a concave lens that is arranged in a light collecting region of the ball lens;
a reflection element that is arranged in association with the concave lens and has a reflection surface that diffracts and reflects an optical signal collected by the concave lens; and
a light receiving element that is arranged in association with the reflection element and receives the optical signal diffracted and reflected by the reflection surface of the reflection element.

2. The light receiving device according to claim 1, wherein
the reflection element is a reflection type diffractive optical element.

3. The light receiving device according to claim 1, further comprising:
a concave lens array in which a plurality of the concave lenses are arranged in an annular form;
a reflector that includes a plurality of the reflection elements each associated with any one of the plurality of concave lenses included in the concave lens array, the plurality of reflection elements being arranged in an annular form around the concave lens array; and
a light receiving element array that includes a plurality of the light receiving elements each associated with any one of the plurality of reflection elements included in the reflector.

4. The light receiving device according to claim 3, further comprising
at least one liquid crystal lens that is arranged between the reflection element and the light receiving element and collects the optical signal diffracted and reflected by the reflection element toward a light receiving portion of the light receiving element.

5. The light receiving device according to claim 3, further comprising:
a support substrate that has an opening formed between each of the plurality of reflection elements included in the reflector and the light receiving element associated with the reflection element and supports the ball lens, the concave lens array, and the reflector; and
a condenser lens that is arranged below the support substrate and collects the optical signal diffracted and reflected by the reflection surface of each of the plurality of reflection elements included in the reflector toward the light receiving element associated with the reflection element.

6. The light receiving device according to claim 5, wherein
a liquid crystal lens is arranged at the opening of the support substrate.

7. The light receiving device according to claim 5, wherein
a wavelength converter that converts a wavelength of the optical signal is arranged between the condenser lens and the light receiving element array.

8. A reception device comprising:
the light receiving device according to claim 1; and
a reception circuit that acquires a signal received by the light receiving device and decodes the acquired signal.

9. A communication device comprising:
the reception device according to claim 8;
a transmission device that transmits a spatial optical signal; and
a control device that acquires a signal based on a spatial optical signal from another communication device received by the reception device, executes processing according to the acquired signal, and causes the transmission device to transmit a spatial optical signal associated to the executed processing.

10. A communication system comprising:
a plurality of the communication devices according to claim 9, wherein
the plurality of communication devices are arranged to transmit and receive a spatial optical signal to and from each other.
